(19) United States
(12) Patent Application Publication
(10) Pub. No.: US 2026/0291847 A1
(43) Pub. Date: Sep. 24, 2026

(54) DYNAMIC SKILLS-BASED ROUTING IN A NETWORK OF ARTIFICIAL INTELLIGENCE AGENTS VIA NETWORK ROUTING PROTOCOLS

(71) Applicant: Cisco Technology, Inc., San Jose, CA (US)

(72) Inventors: Eric A. Voit, Bethesda, MD (US); Samer M. Salam, Beirut (LB); Arjun Sambamoorthy, San Jose, CA (US)

(21) Appl. No.: 19/088,237

(22) Filed: Mar. 24, 2025

(51) Int. Cl. H04L 45/02; H04L 45/12

(52) U.S. Cl. CPC H04L 45/026; H04L 45/12

(57) ABSTRACT

An example embodiment routes requests over a network to corresponding AI agents capable of handling the requests. A routing mechanism enables each AI agent to advertise their set of skills or capabilities (and/or skills or capabilities of agents reachable by that AI agent) using a conventional or other network routing protocol (e.g., Border Gateway Protocol (BGP), Open Shortest Path First (OSPF), Interior Gateway Protocol (IGP), Intermediate System to Intermediate System, etc.) adapted or modified for semantic routing. The skills or capabilities of an AI agent are represented as boundaries of a polytope in a vector space, and may be advertised via exchanges of the network routing protocol. At intermediate hops between source and target AI agents, polytopes may be processed to summarize skills reachable via an intermediate agent. This allows the intermediate agent to act as the gateway in providing access to skills which might be reachable through it.

### TECHNICAL FIELD

The present disclosure relates to network routing.

### BACKGROUND

As enterprises embrace generative artificial intelligence (AI) to build virtual assistants (or agents), these assistants are specialized in their respective domains in order to offer guarantees on performance metrics, such as precision and reliability. This is accomplished through custom fine-tuned large language models (LLMs), using retrieval-augmented generation (RAG) mechanisms with the proper domain knowledge, or a combination thereof. In order to provide a cohesive customer experience, the specialized agents are interconnected over a fabric that handles request routing from a source agent that receives a user request to a target agent that has the necessary skills to service and answer that request. Each agent may offer its own native user interface, which is typically integrated into one or more of the enterprise products, and can process user queries meant for the agent itself or for agents interconnected over the fabric.

For example, multiple virtual assistants (or agents) may each be configured to cover a corresponding topic (e.g., security products, collaboration, networking, etc.). The agents are interconnected in a fabric that supports request routing to the proper agent that can service a user request or query regardless of which source agent interacts with the user. By way of example, a user may be using a networking agent, and has a query regarding firewall policies that needs to be serviced by a security agent.

An approach to route user requests to an appropriate agent is based on semantic similarity in a vector space. Predefined routing policies are registered by listing example utterances (or phrases) for a given routing policy. The degree of similarity of an embedding of the user query is compared to the example utterances for the various predefined routing policies in order to determine a best matching route.

However, the approach does not support routing based on a context absent in the user utterance. For example, an intent such as “which access-point has the highest client density in my network” may need to be routed to different agents depending on the particular network controller used at a customer site. Since the user phrase itself does not provide the controller type context, nor does the phrase indicate which instance(s) of the right controllers to query, request routing based on semantic analysis of phrases/utterances is insufficient.

### BRIEF DESCRIPTION OF THE DRAWINGS

FIG. 1 is a block diagram of an example network environment in which request routing may be implemented, according to an example embodiment.

FIG. 2 is a flowchart of a method for routing requests to corresponding agents, according to an example embodiment.

FIG. 3 is a flowchart of a method of advertising skills or capabilities of target agents of a domain, according to an example embodiment.

FIG. 4 is a flowchart of a method for determining target agents to process requests, according to an example embodiment.

FIG. 5 is a flowchart of a method for determining target agents by a summarizing agent to process requests, according to an example embodiment.

FIG. 6 is a block diagram of an example network environment in which request routing between domains may be implemented, according to an example embodiment.

FIG. 7 illustrates a modified Border Gateway Protocol (BGP) update message for semantic routing of requests, according to an example embodiment.

FIG. 8 is a block diagram of an example network environment in which request routing within a domain may be implemented, according to an example embodiment.

FIG. 9 illustrates a modified Open Shortest Path First (OSPF) packet for semantic routing of requests, according to an example embodiment.

FIG. 10A illustrates an example vector space for a source agent for determining target agents to process requests, according to an example embodiment.

FIG. 10B illustrates an example vector space for a summarizing agent for determining target agents to process requests, according to an example embodiment.

FIG. 11 illustrates a flowchart of a generalized method for routing requests to corresponding agents, according to an example embodiment.

FIG. 12 illustrates a hardware block diagram of a computing device configured to perform functions associated with routing requests to corresponding agents as discussed herein, according to an example embodiment.

### DETAILED DESCRIPTION

### Overview

An example embodiment provides a skills-based routing mechanism across a network of artificial intelligence (AI) agents based on semantic overlap in a vector space of requests and polytope boundaries representing agent skills or capabilities. The polytope boundaries in the vector space are used for skills advertisement. The example embodiment routes requests over the network to corresponding AI agents capable of handling the requests. The routing mechanism enables each AI agent to advertise their set of skills or capabilities (e.g., the set of user intents and contexts that the AI agent is capable of handling) and/or skills or capabilities of agents reachable by that AI agent using a network routing protocol. The skills or capabilities of an AI agent are represented as boundaries of a polytope in the vector space, and may be advertised via exchanges of the network routing protocol. The network routing protocol may be any conventional or other routing protocol (e.g., Border Gateway Protocol (BGP), Open Shortest Path First (OSPF), Interior Gateway Protocol (IGP), Intermediate System to Intermediate System, etc.) adapted or modified for semantic routing (e.g., advertises polytope boundaries representing skills or capabilities of the AI agents instead of, or in addition to, IP or other addresses). A source agent receives a user request and may handle the user request based on overlap of the request with polytope boundaries of the source agent (representing skills or capabilities of the source agent). Further, the source agent may identify a target or summarizing agent capable of handling (or reaching an agent capable of handling) the user request based on overlap of the request with advertised polytope boundaries (representing skills or capabilities of target agents). The user request is routed to the identified target agent based on a user intent expressed in the user request.

### EXAMPLE EMBODIMENTS

Network routing protocols forward traffic based on groups of addresses. Effectively, a network router receives advertisements from a peer network asserting ownership of a specified address range. Summarization of address ranges allows the network routing protocol to scale. However, with the advent of generative AI, meaning of words may be quantized. This goes beyond simple digitization since numeric calculations can be performed on the meaning underlying words and sentences. Accordingly, an example embodiment routes questions or requests between various entities based on the underlying meaning of the questions. This enables a mesh of relationships to be constructed, thereby enabling forwarding of questions between different virtual assistants (or agents) and organizations.

An example embodiment provides a technique for AI agents capable of answering questions to be able to publish areas of expertise for which they are authoritative. The example embodiment further provides techniques for aggregating the totality of questions answerable through intermediate aggregation points.

An example embodiment determines a target AI agent as a destination for routing of a request or question received by a source AI agent within a network of AI agents. This may be performed within highly scalable network routing protocols modified for semantic routing which route requests or questions to various authoritative sources based on the underlying meaning of the question. Authoritative ownership of various types of meaning is asserted by target AI agents in the form of ranges of quantized embeddings (representing a polytope in a semantic vector space). Each range indicates coverage of a knowledge domain, skill, capability, and/or intent of an AI agent. A routing mechanism enables each AI agent to advertise their set of skills or capabilities (e.g., the set of user intents and contexts that the AI agent is capable of handling) and/or skills or capabilities of agents reachable by that AI agent using a network routing protocol modified for semantic routing.

A user enters a request or question within a local AI (or source) agent of the example embodiment, and an embedding for the request is generated. When the request is outside the scope of the source agent (based on a comparison of the embedding of the request and embedding ranges for the source agent), the request embedding may be sent to target agents capable of handling the request that reside in the same or a different domain as the source agent. The source agent checks the request embedding to determine whether the request embedding falls within ranges of quantized embeddings supported by local target AI agents within the same domain (indicating the target AI agent has sufficient skills or capabilities to handle the request) or supported by remote target AI agents of a different domain.

The source agent may forward the request embedding to one or more local target AI agents based on overlap of the request embedding with advertised polytope boundaries (representing skills or capabilities of the local target AI agents). Further, the source agent may forward the request embedding to a summarizing agent capable of handling (or reaching an agent capable of handling) the user request based on overlap of the request embedding with advertised polytope boundaries from the summarizing agent (representing a summary of skills or capabilities of remote target agents). Results from the target agents may be received and combined by the source agent to produce a result for the request.

In an example embodiment, AI agents advertise a semantic domain of requests or questions for which they are capable of providing an answer via a polytope construct (in a semantic vector space). A semantic meaning being served by an AI agent is advertised to a set of other AI agents via conventional or other network routing protocols modified or adapted to provide request routing across networked AI agents.

An example embodiment provides a manner for how requests or questions can be optimally semantically routed between AI agents of a network. This enables a local AI agent to access a larger variety of back-end remote AI agents when the local AI agent cannot answer a request. The example embodiment further enables an AI agent to summarize multi-dimensional semantic surfaces so as to hide the specifics of individual AI agents (e.g., similar to a proxy gateway, etc.). Accordingly, complex assemblies of various AI agents can be assembled behind any specific local AI agent, where the local AI agent determines the set of questions the local AI agent can semantically answer, forward, proxy, or assert an inability to answer.

In order to provide a cohesive customer experience, an example embodiment provides a network of specialized AI agents and handles request routing from a source agent that receives a user request to a target agent that has the necessary skills to service and answer that request. A mechanism may be implemented where each AI agent provides its own native user interface, which is typically integrated into one or more enterprise products, and can handle user queries meant for the agent itself or for target agents. For example, multiple AI agents may cover security products, collaboration, and networking. In order to offer customers a uniform experience across all of these agents, a network of AI agents supports request routing to a proper AI agent that can service a customer request or query regardless of which source agent interacts with the user (e.g., the user may be using the networking agent, and has a query regarding firewall policies that are to be serviced by a security agent).

In an example embodiment, the semantic routing may be latched. For example, when the target AI agent drives an interactive dialogue with a user, the source agent needs to continue forwarding user utterances to the same target AI agent until the source agent receives an indication from the target AI agent that the dialog completed. A lock/release mechanism between the source and target AI agents is used to determine when a particular semantic routing interaction should be released back to the source AI agent (for routing of requests to other target AI agents).

It will be appreciated that the techniques of example embodiments may be performed for routing of any types of requests or queries (e.g., for any desired information or actions) to any types of artificial intelligence (AI) or other agents capable of processing the requests. Further, the present embodiments may be applied to any structure, framework, and/or network of agents coupled in any fashion. The skills or capabilities of an agent may be based on any attributes pertaining to the types of requests that may be processed by the agent (e.g., products, topics, actions, set of commands, intents, contexts (e.g., network or other environment attributes, etc.), etc.). An intent of an agent may include any natural language or other description of a purpose (or functionality) of the agent. An intent of a request may include any natural language or other description of a purpose (or requested functionality) for the request, while the context may include any attributes pertaining to the request (e.g., item, topic, network or other environment attributes, etc.). In addition, the example embodiments may employ any conventional or other network routing protocols (e.g., Border Gateway Protocol (BGP), Open Shortest Path First (OSPF), Interior Gateway Protocol (IGP), Intermediate System to Intermediate System, etc.) modified or adapted for semantic routing (e.g., to advertise polytope ranges representing skills or capabilities of agents instead of, or in addition to, IP or other addresses) to route a request to any quantity of agents to handle the request in substantially the same manner described below.

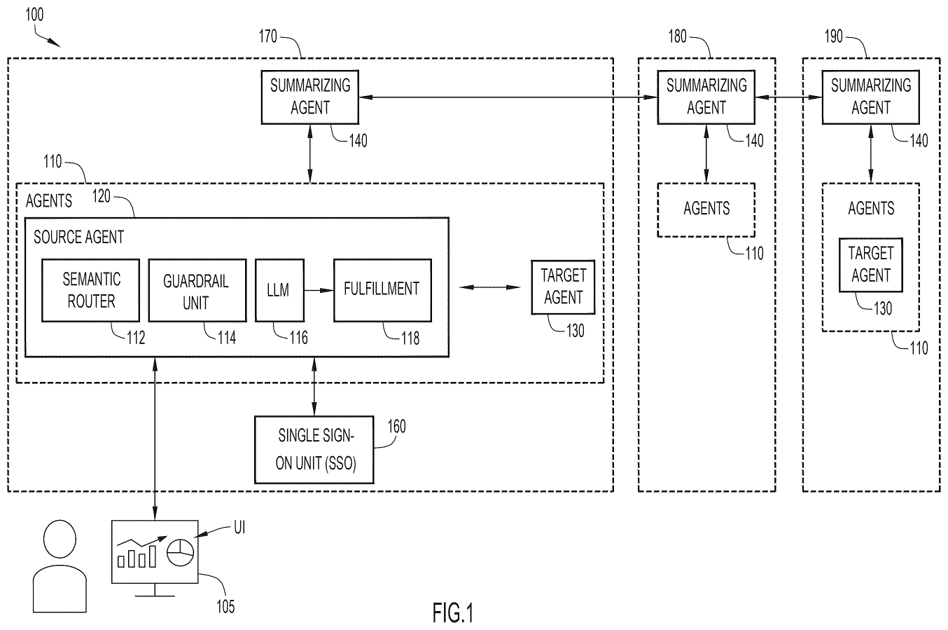

FIG. 1 illustrates an example network environment 100 in which an embodiment presented herein may be implemented. Network environment 100 includes a plurality of sets of agents 110, and a single sign-on (SSO) unit 160. By way of example, the sets of agents 110 each reside within a corresponding domain 170, 180, 190. The domains may each be associated with, or under the control of, a corresponding organizational, authoritative, or other entity. However, network environment 100 may include any quantity of domains and agents 110. Each agent 110 includes skills or capabilities to process certain requests or queries (e.g., certain topics, products, actions, set of commands, etc.). Single sign-on unit 160 provides any conventional or other security that enables access of the network environment and other platforms by a user using a single set of login or other credentials. The security may further provide any conventional or other roles based access control that controls system access for users based on user roles and locations.

By way of example, network environment 100 may be employed for a call or support center to provide responses to requests or queries for information for items (e.g., products, services, etc.). However, the network environment may be employed for various scenarios. The request preferably includes text (or audio converted to text), while the response may include text (or audio converted from text), figures, diagrams, tables, and/or other visual elements.

One or more agents 110 within a domain 170, 180, 190 may serve as a summarizing agent 140 that advertises skills or capabilities of agents 110 within that domain to other domains and/or performs routing within the domain as described below. The skills or capabilities of agents 110 within domains 170, 180, 190 are advertised to a corresponding summarizing agent 140 of that domain (via network routing protocols modified or adapted for semantic routing) to enable routing of requests to the appropriate agents 110 for processing. The summarizing agent basically serves as a type of gateway providing access to agents 110 of a domain for entities external of the domain (e.g., inter-domain communications, etc.).

Agents 110 may include a source agent 120 that receives a request from an end-user device 105 of a user, and one or more target agents 130 with skills or capabilities to process certain requests or queries (e.g., certain topics, products, actions, set of commands, etc.). Any agents 110 within a domain may serve as a source agent 120, target agent 130, and/or summarizing agent 140 to receive and process requests. Source agent 120 provides a user interface (for end-user device 105) to receive requests and provide results for the request. The request preferably includes text (or audio converted to text), while the results preferably include text (or audio converted from text). Further, source agent 120 verifies the user (e.g., via SSO unit 160), and analyzes the request for routing decisions (e.g., routing to a summarizing agent 140 and/or appropriate agents 110 (e.g., source agent 120 and/or target agents 130) with sufficient skills or capabilities to process the request). End-user device 105, source agent 120, target agents 130, summarizing agents 140, and SSO unit 160 may be local to each other and/or communicate over a communication network that may include one or more wide area networks (WANs), such as the Internet, and one or more local area networks (LANs). These components may communicate with each other over the communication network using a variety of known or hereafter developed communication protocols.

Source agent 120 includes a semantic router 112, a guardrail unit 114, and an LLM 116. Target agents 130 and summarizing agents 140 may be substantially similar to source agent 120 and include these components. Semantic router 112 analyzes a request for routing according to example embodiments as described below. Guardrail unit 114 may monitor the request and results from LLM 116 for malicious queries, queries outside the terms of service, and/or hallucinations (or incorrect or irregular results) from LLM 116 and perform remedial actions (e.g., discard an improper request or irregular results, etc.) via any conventional or other techniques.

LLM 116 processes a request and produces results or fulfillment 118 when source agent 120 has sufficient skills or capabilities to process the request. By way of example, LLM 116 may employ any conventional or other large language model (LLM) and natural language processing (NLP) techniques to process the request and provide requested information and/or perform actions. These techniques can parse and understand text, and extract various elements, data types, tasks, and other relevant information. This information can be used to produce results for the request. The LLM may receive a prompt or natural language instruction, and process the prompt to determine the actions to be performed to produce the results. The prompt may include several variations and forms.

However, any quantity of any conventional or other machine learning and/or natural language processing (NLP) models may be used (e.g., mathematical/statistical models, classifiers, feed-forward (fully or partially connected), recurrent (RNN), convolutional (CNN), or other neural networks, deep learning models, long short-term memory (LSTM), attention-based methods/transformers, large language model (LLM), entity extraction, relationship extraction, part-of-speech (POS) taggers, semantic analysis, etc.) that are configured to provide the corresponding skills or capabilities for handling certain requests associated with an agent 110 (e.g., certain topics, products, actions, set of commands, etc.).

For example, neural networks may include an input layer, one or more intermediate layers (e.g., including any hidden layers), and an output layer. Each layer includes one or more neurons, where the input layer neurons receive input (e.g., text or text features, etc.), and may be associated with weight values. The neurons of the intermediate and output layers are connected to one or more neurons of a preceding layer, and receive as input the output of a connected neuron of the preceding layer. Each connection is associated with a weight value, and each neuron produces an output based on a weighted combination of the inputs to that neuron. The output of a neuron may further be based on a bias value for certain types of neural networks (e.g., recurrent types of neural networks).

The weight (and bias) values may be adjusted based on various training techniques. For example, the machine learning of the neural network may be performed using a training set of various text (e.g., request/query, etc.) as input and corresponding desired outputs (e.g., results for requests or queries, actions to perform to retrieve results for requests or queries, etc.), where the neural network attempts to produce the provided output and uses an error from the output (e.g., difference between produced and known outputs) to adjust weight (and bias) values (e.g., via backpropagation or other training techniques).

The output layer neurons may indicate a probability for the input data being associated with a corresponding output (e.g., results for requests or queries, actions to perform to retrieve results for requests or queries, etc.). The output with the highest probability may be selected as the result.

Agents 110 within a domain 170, 180, 190 advertise their skills and capabilities to a corresponding summarizing agent 140 and/or neighboring agents 110 of that domain via a network routing protocol modified or adapted for semantic routing as described below. The summarizing agent may combine or summarize the skills or capabilities of the agents and advertise the summary to other domains via a network routing protocol modified or adapted for semantic routing as described below. A source agent 120 of a domain 170, 180, 190 receiving a request may determine one or more local target agents 130 of the same domain with sufficient skills or capabilities to process a request and send the request to those agents for processing. Alternatively, the source agent may send a request to a corresponding summarizing agent 140 to route the request to an appropriate target agent 130 residing in a different domain to process the request.

By way of example, source agent 120 of domain 170 may receive a request from end-user device 105. Semantic router 112 of source agent 120 analyzes the request to render routing decisions. For example, semantic router 112 may determine that source agent 120 has sufficient skills or capabilities to process the request. In this case, the request is processed by LLM 116 of source agent 120, and the results are returned to end-user device 105.

When semantic router 112 of source agent 120 determines that one or more local target agents 130 of domain 170 advertising with source agent 120 have sufficient skills or capabilities to process the request, semantic router 112 routes the request from source agent 120 to the determined target agents. The determined target agents process the request (e.g., via their corresponding LLMs 116 in substantially the same manner described above) and return results to source agent 120. The source agent combines the results from the target agents and provides an overall result to end-user device 105.

When semantic router 112 of source agent 120 determines that a summarizing agent 140 of domains 170, 180, 190 is associated with (or enables a path to) agents having sufficient skills or capabilities to process the request, semantic router 112 of source agent 120 routes the request (or embedding of the request) to that summarizing agent. The summarizing agent determines target agents 130 having sufficient skills or capabilities to process the request. The request may traverse a plurality of summarizing agents of different domains until reaching a domain with a target agent capable of handling the request. The summarizing agent receives information for the target agents from advertisements (e.g., IP or other network address, agent identity, corresponding polytope boundaries representing skills or capabilities of the remote target agent, etc.) to route the request.

The summarizing agent forwards the request to the determined target agents. The determined target agents process the request (e.g., via their corresponding LLMs 116 in substantially the same manner described above) and return results (via the summarizing agent) to source agent 120. The source agent combines the results and provides an overall result to end-user device 105.

For example, an actual user request or question may be received by source agent 120 of domain 170. The source agent lacks sufficient confidence to answer a specific question locally, or has attempted to answer the question but metrics suggest the answer is sub-optimal. In this case, the question is tagged to be passed by source agent 120 to a peer or neighboring agent within domain 170, or to a summarizing agent 140 of domain 180 for routing to an agent in another domain (e.g., target agent 130 of domain 190). The skills or capabilities of the peer agents are advertised to agents within domain 170 and to summarizing agent 140 (e.g., the skills or capabilities of the agents are represented by polytope boundaries in a semantic vector space). Source agent 120 determines the best fit polytope(s) corresponding to the peer agents or a summarizing agent 140 (of the same or another domain) better suited to answer the question. When the peer agents can answer the question, the request is forwarded to the peer agents for processing.

When a summarizing agent 140 is associated with external agents capable of answering the question, the request is forwarded to the summarizing agent (of another domain) for routing to the external agents. The request may traverse a plurality of summarizing agents 140 of different domains until reaching a domain with a target agent capable of handling the request. By way of example, the request from source agent 120 may be sent to summarizing agent 140 of domain 180 (based on advertised polytopes), and forwarded to summarizing agent 140 of domain 190 (based on advertised polytopes). Summarizing agent 140 of domain 190 routes the request to target agent 130 of domain 190 to process the request. The results from the peer and/or external agents are provided to source agent 120 and combined to produce a result for the question.

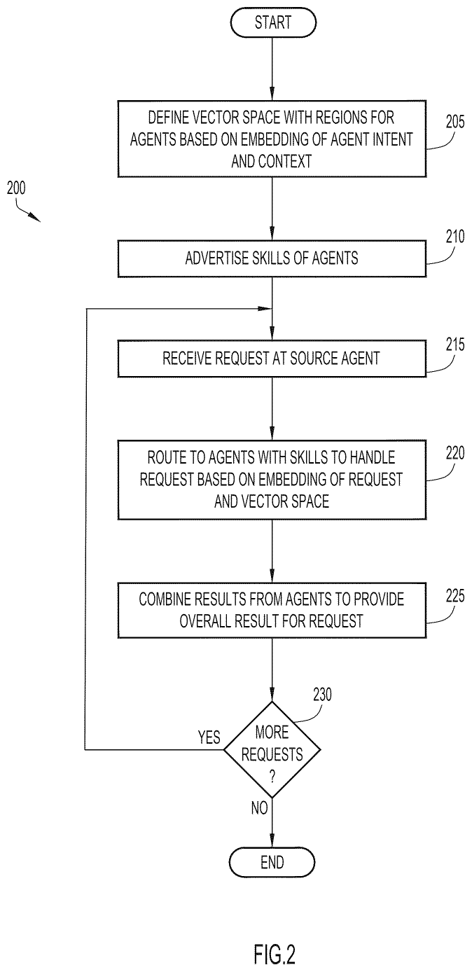

With continued reference to FIG. 1, FIG. 2 illustrates a method 200 for routing requests to corresponding agents, according to an example embodiment. Initially, a vector or multidimensional space is defined based on embeddings of intent and context for each of agents 110 (e.g., (intent, context)-tuples) at operation 205. The intent and context indicate skills or capabilities of an agent 110. Basically, each word or phrase (or tuple) may be represented by a vector (or embedding) having numeric elements corresponding to a plurality of dimensions (of the vector space). Words (or phrases or tuples with) similar meanings have similar word embeddings or vector representations. The word embeddings are produced from machine learning techniques or models (e.g., neural network as described above, etc.) based on an analysis of word usage in a collection of text or documents. The embeddings or vector representations may be pre-existing, and/or produced using any conventional or other tools or techniques (e.g., GLOVE, WORD2VEC, SBERT, etc.).

The dimensions of the embeddings correspond to dimensions of the vector space to map the embeddings to the vector space. In other words, an embedding may serve as coordinates in the vector space to identify a location in the vector space for the embedding (e.g., intent and context, etc.). The collective (intent, context) embeddings of each agent 110 occupy a corresponding discrete region in the vector space. The region may include two or more dimensions. By way of example, the region includes a convex polytope (e.g., n-dimensional generalization of a convex polygon within that n-dimensional space). In an example embodiment, the polytopes can be n-dimensional hypercubes. In other words, each region defines the entire set of skills or capabilities (e.g., intents, contexts, etc.) for a corresponding agent 110 and, thus, represents the boundary of the agent skills or capabilities. The regions of agents 110 may overlap which enables user requests to be multicast to, and processed by, more than one agent 110 as described below.

For example, an agent 110 can have each supported intent and context (e.g., skill or capability) indicated by a vector (or embedding) of ranges defined by minimum and maximum values for each dimension (e.g., based on different terminology or expressions for the intent and context, etc.). By way of example, a vector of n dimensions may be expressed as: {[dimension 1 (minimum value, maximum value)], [dimension 2 (minimum value, maximum value)], . . . [dimension n (minimum value, maximum value]}.

The totality of requests or queries which can be answered by a specific agent 110 may be represented as a set of these vectors (which define the boundaries of the region for the agent in the multidimensional or vector space). The set of vectors enables determination of whether a request or query is within the purview of skills or capabilities of a specific agent. By way of example, a request may be encoded as a single n-dimensional request vector (or embedding) in substantially the same manner described above. The request vector may be expressed as: {[dimension1], [dimension 2], . . . , [dimension n]}. The determination may be accomplished by numerical comparisons which check whether the dimensions of the request vector are within the dimension ranges (of the set of vectors) for the intents and contexts supported by an agent.

The skills or capabilities of an agent 110 may be based on any attributes pertaining to the types of requests that may be processed by the agent (e.g., products, topics, actions, set of commands, intents, contexts (e.g., network or other environment attributes, etc.), etc.). An intent of an agent 110 may include any natural language or other description of a purpose (or functionality) of the agent. By way of example, the skills or capabilities (e.g., intent and context, etc.) for an agent 110 may include client IP address pools for each managed virtual routing and forwarding (VRF) for a network macro-segment, network device IP address pools (e.g., for NetOps device management), geographic segmentation (e.g., an area under responsibility of a network controller), various tenants supported within a network controller datastore, different services maintained for service level agreements (SLAs) (e.g., level 2 VPN (L2VPN), level 3 VPN (L3VPN), etc.), and/or namespace division (e.g., context of managed objects under a network controller). Embeddings for one or more of these intents and contexts for an agent 110 may be generated to determine the region in the vector space indicating the boundary of skills or capabilities for the agent.

An example embodiment steers requests or questions to an authoritative (target) agent from a source agent (receiving a question) without one or more centralized directories. Further, the source agent may be unaware of traversal of intermediate summarizing agents to reach the target agent. Peering relationships are employed to bind all agents. Continuous peer adjacency and topology maintenance has similarities with network routing protocols. However, instead of exchanging IP address ranges (and summarizing sub-networks), an example embodiment modifies or adapts network routing protocols to exchange sets of intents as represented by dimensional (or polytope) ranges. These intents are designated as reachable by the link adjacency capabilities of network routing protocols. In other words, a mesh of trusted agents maintains the set of questions that can be forwarded to each other. This maintenance of the specific question dimensional ranges (or polytopes) is dynamically supported by the network routing protocol exchanges.

Accordingly, agents 110 of a domain 170, 180, 190 dynamically advertise their skills or capabilities with peer (or neighboring) agents and/or a corresponding summarizing agent 140 at operation 210 via a network routing protocol modified or adapted for semantic routing. Summarizing agents may advertise the skills or capabilities of their associated agents to other domains. In this case, the skills or capabilities of the agents may be aggregated to produce a summary, where the summary is provided to the other domains to hide details of the associated agents. This enables the summarizing agent to own the business relationship of how to reach the associated agents. Effectively, the summarizing agent is the middleman which simplifies access to the associated agents.

A user request from an end-user device 105 is received at a source agent 120 of a domain at operation 215. Semantic router 112 of source agent 120 analyzes the request to render routing decisions for determining agents (e.g., source agent 120, local target agents 130 within the same domain, summarizing agent 140 for access to target agents of different domains) with sufficient skills or capabilities to process the request at operation 220. For example, semantic router 112 of source agent 120 determines an embedding of the request (e.g., embedding of intent (or desired functionality) and context within the request), and identifies potential regions within a vector space for the source agent and/or local target agents 130 advertising with the source agent that encompass the embedding of the request. The intent and context of the request may be determined using any conventional or other natural language processing (NLP) techniques.

When the region of source agent 120 is identified, the source agent may process the request (e.g., via LLM 116) to produce results. In other words, if the coordinates of the vector representing the embedding of the user request fall or reside within the region of the source agent, then the source agent may process the request. When one or more regions of local target agents 130 advertising with source agent 120 are identified, source agent 120 routes or sends the request (e.g., directly or via a local summarizing agent 140) to the local target agents associated with the one or more identified regions to process the request (e.g., via corresponding LLMs 116 of the local target agents). In other words, if the coordinates of the vector representing the embedding of the user request fall or reside within the regions of one or more local target agents, then the one or more remote local agents may process the request. The results of the request from local target agents 130 are returned to source agent 120.

However, source agent 120 may employ various conventional or other techniques to determine the best/proper embedding vector match between the request embedding and the source agent or local target agent polytopes (e.g., the request embedding residing within all polytope ranges, a VectorDB or other search, cosine similarity, principal component analysis to determine which dimensions are relevant for comparison, etc.) in substantially the same manner described below.

In the event that the embedding of the request resides within the region of a summarizing agent 140 of the same or different domain (e.g., accessing remote target agents), the request is routed or sent by source agent 120 to a summarizing agent 140 to forward the request to a remote (or external) target agent capable of processing the request. The request may traverse a plurality of summarizing agents of different domains until reaching a domain with a target agent capable of handling the request. The traversal may be based on advertised polytopes of the summarizing agents of the different domains. The remote target agent processes the request (e.g., via corresponding LLMs 116 of the remote target agent).

The results of the request are returned from the local and/or remote target agents 130 to source agent 120 (e.g., directly or via one or more summarizing agents 140). The results from the identified agents (source, local target, and/or summarizing agents) are combined by source agent 120 to produce an overall result at operation 225 that is provided to end-user device 105 in response to the request. The above process is repeated from operation 215 for additional requests until the requests have been processed as determined at operation 230.

In an example embodiment, the semantic routing may be latched. For example, when a local or remote target agent 130 drives an interactive dialogue with a user, source agent 120 is to continue forwarding user utterances to the same local or remote target agent 130 until source agent 120 receives an indication from the local or remote target agent that the dialog completed. A lock/release mechanism between the source and local or remote target agents is used (e.g., flag, parameter value, semaphore, etc.) to determine when a particular semantic routing interaction should be released back to the source agent (e.g., for routing requests to other local or remote target agents, etc.).

An example embodiment may include a default summarizing agent of last resort where out-of-scope requests or questions are forwarded. The question embedding (or the text question) may be sent from source agent 120 when a local cache miss occurs for the semantic meaning of the question with respect to a polytope. Accordingly, continuous replication of questions/meanings need not be maintained until a question is asked.

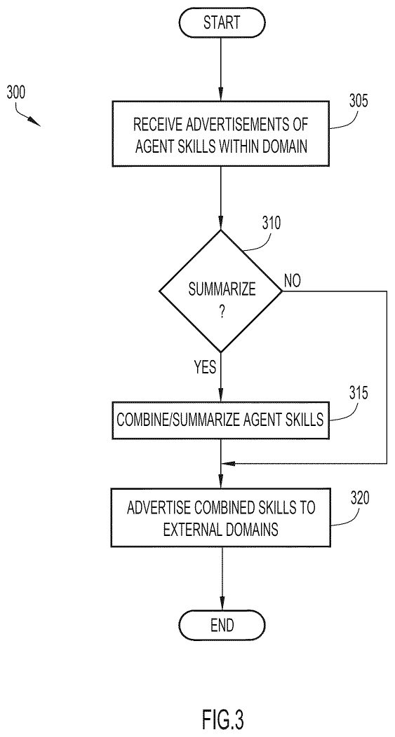

With continued reference to FIGS. 1 and 2, FIG. 3 illustrates a method 300 of advertising skills or capabilities of target agents of a domain, according to an example embodiment. This may correspond to operation 210 of FIG. 2. Initially, a vector or multidimensional space is defined based on embeddings of intent and context for each of agents 110 (e.g., (intent, context)-tuples) in substantially the same manner described above. The collective (intent, context) embeddings of each agent 110 occupy a corresponding discrete region in the vector space. In other words, each region defines the entire set of skills or capabilities (e.g., intents, contexts, etc.) for a corresponding agent 110 and, thus, represents the boundary of the agent skills or capabilities in substantially the same manner described above.

An example embodiment steers questions to an authoritative (target) agent from the source agent (receiving the question) without one or more centralized directories as described above. An example embodiment modifies or adapts network routing protocols to exchange sets of intents as represented by dimensional (or polytope) ranges. These intents are designated as reachable by the link adjacency capabilities of network routing protocols. In other words, a mesh of trusted agents maintains the set of questions that can be forwarded to each other. This maintenance of the specific question dimensional ranges (or polytopes) is dynamically supported by the network routing protocol exchanges.

Accordingly, agents 110 of a domain dynamically advertise their skills or capabilities (and skills or capabilities of agents 110 accessible by that agent) with peer (or neighboring) agents and a summarizing agent 140 of the domain via a network routing protocol modified or adapted for semantic routing. The agents and summarizing agent receive the advertisements at operation 305. Advertising may be accomplished by an agent 110 providing bounds of the corresponding region or polytope in the vector space (defining the agent skills or capabilities) to a peer (or neighboring) agent and/or summarizing agent 140 within the domain. The bounds may be represented by the set of vectors described above or by any quantity of any types of coordinate values in the vector space to indicate the boundaries of the region.

Agents 110 and/or summarizing agent 140 receive and evaluate the advertisements to update their registration and routing information accordingly (e.g., routing tables, databases, etc.). Agents within a same domain provide a higher level of trust (e.g., since a same entity owns/controls the domain, etc.). Thus, identity information of agents 110 (e.g., IP or other network address, agent identity, corresponding polytope boundaries representing skills or capabilities of the agent, etc.) is preferably shared (in advertisements) between the agents of the same domain. However, agents 110 of a different domain have a lower level of trust (e.g., since a different entity owns/controls the different domain, etc.). In this case, summarizing agent 140 of a domain may hide details or information of associated local agents within the domain (e.g., IP or other network address, agent identity, corresponding polytope boundaries representing skills or capabilities of the agent, etc.) when advertising their skills or capabilities to other domains. This may be accomplished by summarizing (e.g., combining or aggregating) the polytope ranges of the skills or capabilities of the associated agents within the domain. The summarizing agent retains the identity information of the local agents (e.g., IP or other network address, agent identity, corresponding polytope boundaries representing skills or capabilities of the agent, etc.) to route requests from other domains to those agents. The advertisement from the summarizing agent to other domains further provides information (e.g., IP or other network address, identity, etc.) of the summarizing agent for routing requests from other domains to the summarizing agent.

When summarization is to be performed as determined at operation 310, summarizing agent 140 combines or summarizes the skills or capabilities of associated agents 110 based on evaluating the advertisements of the associated agents at operation 315. The summarization allows the summarizing agent to abstract the specifics of the associated agents within the domain. This also allows the summarizing agent to own the relationship with the source agent since information of the local agents capable of answering the question is not released.

By way of example, the summary may include a range for each dimension of region (or polytope) boundaries, where the range comprises the largest maximum value and lowest minimum value for that dimension from the advertisements (or skills or capabilities of the agents). Further, groups or communities of polytopes that are similar may be identified and combined or aggregated for the summary. In addition, any conventional or other principal component analysis (PCA) may be employed to determine which dimensions of the region boundaries should be combined or aggregated for the summary. PCA basically reduces data dimensions while retaining a maximum amount of information. The determined dimensions of the region boundaries may be combined in substantially the same manner described above (e.g., the range for determined dimensions are provided in the summary and each comprises the largest maximum value and lowest minimum value for that determined dimension from the advertisements, etc.).

Summarizing agent 140 advertises the skills or capabilities of the associated local agents to peer or neighboring agents (e.g., neighboring agents 110 or summarizing agents 140) within and/or external of the domain at operation 320. The summarizing agent may provide identity information or the summary based on a level of trust. The summary enables the summarizing agent to hide the associated target agents from devices outside the domain. Various conventional or other network routing protocols may be modified or adapted for semantic routing to support passing of dimensional ranges (or polytopes) between peer or neighboring agents (either summarized or not summarized) as described below.

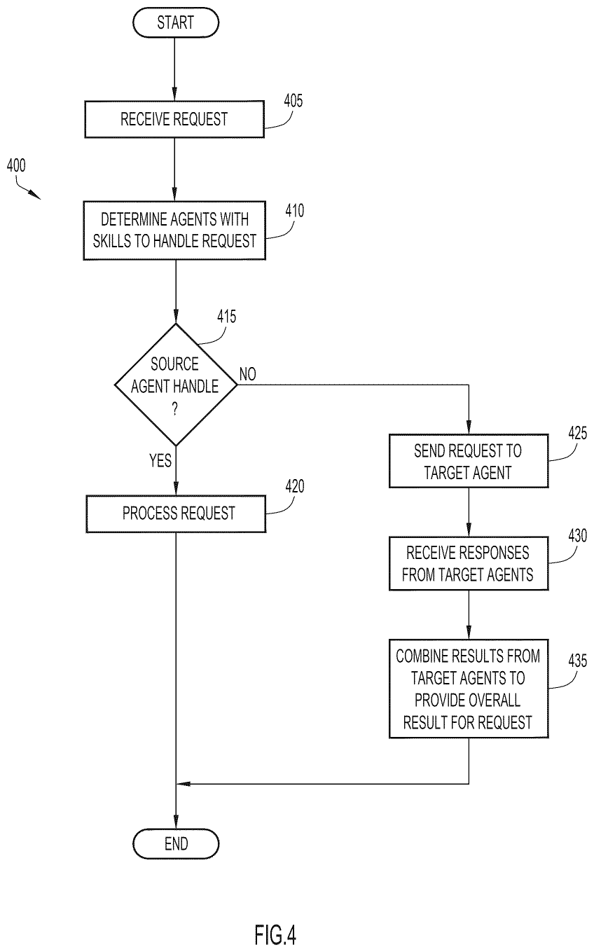

With continued reference to FIGS. 1-3, FIG. 4 illustrates a method 400 for determining target agents to process requests, according to an example embodiment. This may correspond to operations 220 and 225 of FIG. 2. Initially, a vector or multidimensional space is defined based on embeddings of intent and context for each of agents 110 (e.g., (intent, context)-tuples) in substantially the same manner described above. The collective (intent, context) embeddings of each agent 110 occupy a corresponding discrete region in the vector space. In other words, each region defines the entire set of skills or capabilities (e.g., intents, contexts, etc.) for a corresponding agent 110 and, thus, represents the boundary of the agent skills or capabilities in substantially the same manner described above. Agents 110 dynamically advertise their skills or capabilities with peer (or neighboring) agents of a domain and/or a corresponding summarizing agent 140, while summarizing agent 140 advertises skills or capabilities of associated local agents within a domain and/or to external domains in substantially the same manner described above.

A user request from an end-user device 105 is received at a source agent 120 at operation 405. Semantic router 112 of source agent 120 analyzes the request to render routing decisions for determining agents (e.g., source agent 120, local target agents 130 within the same domain, and remote target agents 130 of another domain) with sufficient skills or capabilities to process the request at operation 410. For example, semantic router 112 of source agent 120 determines an embedding of the request (e.g., embedding of intent (or desired functionality) and context within the request), and identifies potential regions within a vector space for the source agent, local target agents 130, and/or a summarizing agent 140 advertising to the source agent that encompass the embedding of the request. The intent and context of the request may be determined using any conventional or other natural language processing (NLP) techniques.

When a region of source agent 120 is identified as determined at operation 415, the source agent may process the request (e.g., via LLM 116) to produce results at operation 420. In other words, if the coordinates of the vector representing the embedding of the user request fall or reside within the region of the source agent, then the source agent may process the request.

When the region of source agent 120 is not identified as determined at operation 415, the request may be within a region of one or more local target agents 130 and/or one or more summarizing agents 140 (for access to other local target agents and/or remote target agents of other domains). When one or more regions of local target agents 130 advertising to source agent 120 are identified, source agent 120 routes or sends the request (e.g., directly or via summarizing agent 140) to the local target agents associated with the one or more identified regions to process the request (e.g., via corresponding LLMs 116 of the local target agents) at operation 425. In other words, if the coordinates of the vector representing the embedding of the user request fall or reside within the regions of one or more local target agents 130, then the one or more target agents may process the request.

When the request corresponds to a region of a summarizing agent 140 (e.g., a region of the summarizing agent is identified that contains the embedding of the request, etc.), semantic router 112 of source agent 120 routes or sends the request to summarizing agent 140 at operation 425. An example embodiment may receive advertisements from multiple summarizing agents 140 of different domains, each enabling routing of a request or question set for which agents of that domain can provide guidance.

Source agent 120 may determine one or more summarizing agents 140 to receive the request. This may be accomplished by comparing the request embedding to region summaries (or agent region boundaries) advertised by the summarizing agents. The source agent may determine the one or more summarizing agents based on the region boundaries encompassing or being closest to the request embedding in substantially the same manner described above (for selecting local target agents).

Summarizing agent 140 determines the associated (local and/or remote) target agents capable of handling the request. This may be accomplished by comparing the request embedding (corresponding to coordinates in the vector space) to boundaries of the regions (corresponding to the associated target agents) provided during skills advertisement in substantially the same manner described above. The request may traverse a plurality of summarizing agents of the same and/or different domains until reaching a target agent capable of handling the request. This may be based on a comparison of the request to polytope ranges (or summaries) advertised by summarizing agents of the domains. Thus, an embodiment may provide multi-hop routing (within and between domains) to identify and route requests to target agents.

Once the local or remote target agents are identified, summarizing agent 140 routes or sends the request to the local or remote target agents 130 to process the request (e.g., via corresponding LLMs 116 of the local or remote target agents). Local or remote target agents 130 provide the response to summarizing agent 140 for forwarding to source agent 120.

Source agent 120 may employ various conventional or other techniques to determine the best/proper embedding vector match between the request embedding and the source agent, local target agent, and/or summarizing agent polytopes (e.g., the request embedding residing within all polytope ranges, a VectorDB or other search, cosine similarity, principal component analysis to determine which dimensions are relevant for comparison, etc.) in substantially the same manner described below.

Further, there may be scenarios where the request embedding is contained within more than one region due to overlapping. In this case, a selection technique may be employed to identify an appropriate region and corresponding source agent 120, local target agent 130, and/or summarizing agent 140. For example, each of source, local target, and summarizing agents associated with the regions containing the request embedding may be selected (e.g., the request may be routed or sent (multicast) to each of those agents). Further, the region having the closest or most explicit match may be selected. This may be determined based on any conventional or other distances of the request embedding to portions of the region (e.g., a request embedding having a greater distance from region boundaries or closer to a region center may represent a closer match, etc.). Moreover, overlapping region segments may be trimmed to resolve ambiguity (or remove the overlap) prior to receipt of the request (e.g., the region with less overlap may be trimmed, etc.).

In addition, source agent 120 may cache matching polytope ranges (or local target agents or summarizing agents). In this case, source agent 120 may compare the request to the requests in the cache via any conventional or other techniques (e.g., distance, cosine similarity, text matching, etc.). When a match occurs, source agent 120 sends the request to the corresponding local target or summarizing agent. Thus, source agent 120 may avoid continually processing the same or similar requests. The cache may be refreshed based on any desired time periods, events, or updates.

Source agent 120 receives the results from local target agents 130 and/or summarizing agent 140 at operation 430, and combines the results from the local target agents and/or summarizing agent 140 at operation 435 to produce an overall result for the request that is provided to end-user device 105. For example, the results of the source agent, local target agents, and/or remote target agents (via the summarizing agents) may be aggregated, collated, joined, merged, or otherwise combined or formatted to produce the overall result. By way of example, a request may be provided to agents 110 with different specialties that may produce varying information for the request. Source agent 120 extracts the appropriate information (e.g., may ignore duplicate or cumulative information, identify relevant information for the request, etc.) from the agent results via any conventional or other techniques to produce the overall result.

An intermediate agent 110 or summarizing agent 140 may receive a request along a route to a local or remote target agent 130 capable of handling the request. In this case, the agent 110 or summarizing agent 140 may analyze the request to forward the request to another local target agent or summarizing agent based on comparisons of the request to advertised polytope ranges (or summaries) in substantially the same manner described above. Thus, an embodiment may provide multi-hop routing (within and between domains) to identify and route requests to the local or remote target agents capable of handling the request.

In an example embodiment, the semantic routing may be latched. For example, when a local or remote target agent 130 drives an interactive dialogue with a user, source agent 120 continues forwarding user utterances to the same local or remote target agent 130 until source agent 120 receives an indication from the local or remote target agent that the dialog completed. A lock/release mechanism between the source and local or remote target agents is used (e.g., flag, parameter value, semaphore, etc.) to determine when a particular semantic routing interaction should be released back to the source agent (e.g., for routing requests to other local or remote target agents, etc.).

An example embodiment may include a default summarizing agent of last resort where out-of-scope requests or questions are forwarded. The question embedding (or the text question) may be sent from source agent 120 when a local cache miss occurs for the semantic meaning of the question with respect to a polytope. Accordingly, continuous replication of questions/meanings need not be maintained until a question is asked.

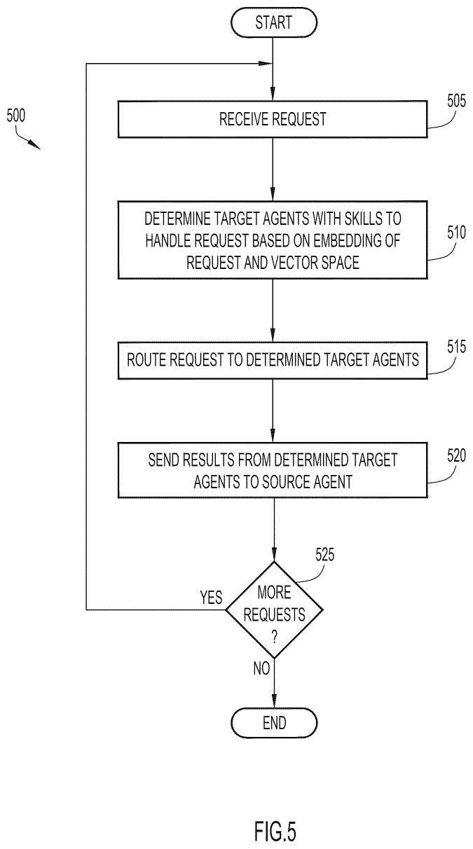

With continued reference to FIGS. 1-4, FIG. 5 illustrates a method 500 for determining target agents by a summarizing agent to process requests, according to an example embodiment. This may correspond to operation 220 of FIG. 2. Initially, a source agent 120 receives a request that may be handled by a local or remote target agent 130 associated with a different summarizing agent within the same or different domain. The request is ultimately received at a summarizing agent 140 associated with one or more target agents 130 capable of handling the request in substantially the same manner described above. An embedding for the request may be produced by source agent 120 and sent to summarizing agent 140, or the summarizing agent may receive a text request and generate the embedding for the request.

Summarizing agent 140 receives the request at operation 505. The summarizing agent determines one or more associated target agents 130 to handle the request at operation 510. For example, summarizing agent 140 identifies potential regions within the vector space for associated target agents 130 that encompass or contain the embedding of the request. This may be accomplished by comparing the request embedding (corresponding to coordinates in the vector space) to boundaries of the regions corresponding to associated target agents 130 provided during advertisement. Summarizing agent 140 may employ various conventional or other techniques to determine the best/proper embedding vector match between the request embedding and advertised regions or polytopes to identify the best target agent (e.g., request embedding residing within all polytope ranges, a VectorDB or other search, cosine similarity, principal component analysis to determine which dimensions are relevant for comparison, etc.).

By way of example, the potential regions for associated target agents 130 may be identified when each dimension of the request embedding resides within each range for the dimension of a region or polytope. However, there may be scenarios where the request embedding is contained within more than one region due to overlapping. In this case, a selection technique may be employed to identify an appropriate region and corresponding target agent 130. For example, each of the target agents associated with the regions containing the request embedding may be selected (e.g., the request may be routed or sent (multicast) to each of those target agents). Further, the region having the closest or most explicit match may be selected. This may be determined based on any conventional or other distances of the request embedding to portions of a region (e.g., a request embedding having a greater distance from region boundaries or closer to a region center may represent a closer match, etc.). Moreover, overlapping region segments may be trimmed to resolve ambiguity (or remove the overlap) prior to receipt of the request (e.g., the region with less overlap may be trimmed, etc.).

Further, when no region is identified that encompasses the request, summarizing agent 140 may identify a closest or nearest region to the embedding of the request. This may be determined based on a shortest distance in the vector space between the request embedding and one or more boundaries of the regions using any conventional or other techniques (e.g., Euclidean or other distance metrics, cosine similarity, etc.).

Moreover, a distance (e.g., Euclidean distance, etc.) or cosine similarity value may be determined between the request embedding and region boundaries. The potential regions may be identified when the distance or cosine similarity values satisfy a threshold. In addition, any conventional or other principal component analysis (PCA) may be employed to determine which dimensions of the request embedding and region boundaries should be compared. PCA basically reduces data dimensions while retaining a maximum amount of information. The determined dimensions of the request embedding and region boundaries may be compared in substantially the same manner described above (e.g., request embedding residing within all polytope ranges, a VectorDB or other search, cosine similarity, etc.).

Once the associated target agents are identified by summarizing agent 140, the summarizing agent routes the request to the associated target agents at operation 515, and forwards results from the associated target agents to source agent 120 at operation 520. The process repeats from operation 505 until the request are processed as determined at operation 525.

In addition, a summarizing agent may receive advertisements from other summarizing agents of the same or other domains (e.g., summarized polytope ranges representing skills or capabilities of associated agents in those other domains). In this case, the summarizing agent may compare the request embedding to the advertised polytope ranges from the other summarizing agents (along with the associated target agents of the summarizing agent). When the request embedding resides within the polytope ranges from another summarizing agent, the request may be forwarded to that other summarizing agent for processing. Thus, the request may traverse a plurality of summarizing agents of the same and/or different domains until reaching a target agent capable of handling the request.

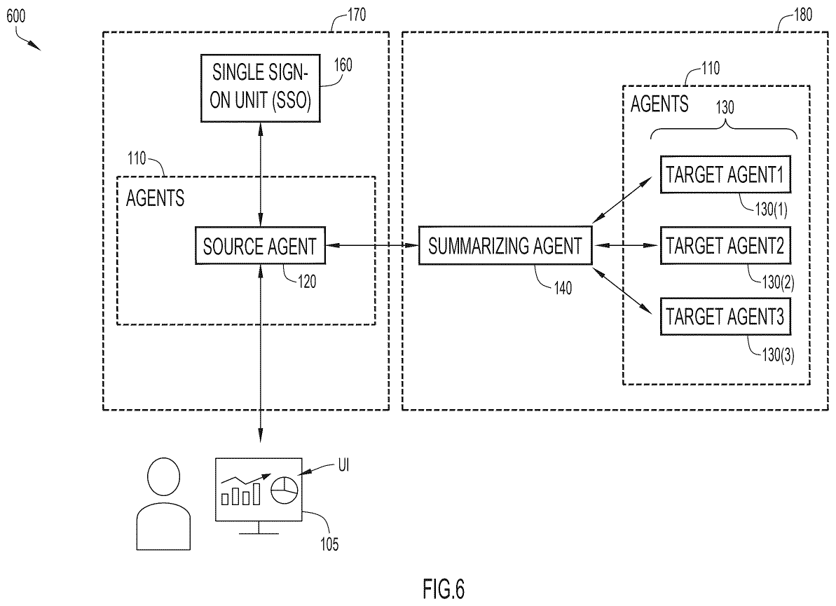

With continued reference to FIGS. 1-5, FIG. 6 illustrates an example network environment 600 in which request routing between domains may be implemented, according to an example embodiment. Network environment 600 is similar to network environment 100 described above, and includes domain 170 and domain 180. Domain 170 includes source agent 120 to receive a request from end-user device 105 of a user, and single sign-on unit 160. Domain 180 includes one or more target agents 130 with skills or capabilities to process certain requests or queries (e.g., certain topics, products, actions, set of commands, etc.), and one or more summarizing agents 140 for inter-domain routing. By way of example, domain 180 includes target agents 130(1), 130(2), and 130(3) (e.g., TARGET AGENT1, TARGET AGENT2, and TARGET AGENT3 as viewed in FIG. 6) and summarizing agent 140.

Source agent 120 provides a user interface (for end-user device 105) to receive requests and provide results for the request. The request preferably includes text (or audio converted to text), while the results preferably include text (or audio converted from text). Further, source agent 120 verifies the user (e.g., via single sign-on (SSO) unit 160), and analyzes the request for routing decisions (e.g., routing to summarizing agent 140 of domain 180 associated with target agents 130 having sufficient skills or capabilities to process the request). End-user device 105, source agent 120, target agents 130, summarizing agent 140, and SSO unit 160 may be local to each other and/or communicate over a communication network that may include one or more wide area networks (WANs), such as the Internet, and one or more local area networks (LANs). These components may communicate with each other over the communication network using a variety of known or hereafter developed communication protocols.

Target agents 130(1), 130(2), and 130(3) of domain 180 advertise their skills or capabilities (and skills or capabilities of agents accessible to those agents) to a corresponding summarizing agent 140. Summarizing agent 140 combines or summarizes the skills or capabilities from the target agents in substantially the same manner described above, and advertises the summary outside of domain 180 to peer (or neighboring) agents of domain 170, such as source agent 120. This enables the summarizing agent to hide target agents 130(1), 130(2), and 130(3) from devices outside of the domain. Source agent 120 may receive a request from end-user device 105. Semantic router 112 of source agent 120 analyzes the request to render routing decisions. By way of example, semantic router 112 determines that summarizing agent 140 is associated with one or more target agents 130 having sufficient skills or capabilities to process the request based on a comparison of the request embedding to the summary (or summarized polytope ranges) in the advertisement in substantially the same manner described above. Semantic router 112 routes the request from source agent 120 to summarizing agent 140. Since summarizing agent 140 receives advertisements from target agents 130(1), 130(2), and 130(3), summarizing agent 140 determines target agents 130 having sufficient skills or capabilities to process the request by comparing the request embedding to polytope ranges for the target agents in substantially the same manner described above. The summarizing agent receives information for the determined target agents (e.g., IP or other network address, agent identity, corresponding polytope boundaries representing skills or capabilities of the target agent, etc.) in advertisements to route the request to the determined target agents.

The determined target agents process the request (e.g., via their corresponding LLMs 116 in substantially the same manner described above) and return results to source agent 120 (via summarizing agent 140). The source agent combines the results and provides an overall result to end-user device 105.

An example embodiment steers requests or questions to an authoritative (target) agent from a source agent (receiving a question) without one or more centralized directories as described above. Continuous peer adjacency and topology maintenance has similarities with network routing protocols. However, instead of exchanging IP address ranges (and summarizing sub-networks), an example embodiment modifies or adapts network routing protocols to exchange sets of intents as represented by dimensional (or polytope) ranges. These intents are designated as reachable by the link adjacency capabilities of network routing protocols. In other words, a mesh of trusted agents maintains the set of questions that can be forwarded to each other. This maintenance of the specific question dimensional ranges (or polytopes) is dynamically supported by the network routing protocol exchanges.

By way of example, an embodiment may employ a modified Border Gateway Protocol (BGP) to exchange polytope boundaries representing skills or capabilities of the agents. Briefly, BGP is an inter-domain routing protocol that introduces a concept of administrative domains by organizing networks into a set of self-administered autonomous systems (AS) with extensive policy controls. Further, BGP provides confederation to scale/hide private autonomous systems (AS). Network reachability information is exchanged with other BGP systems and includes reachable autonomous systems (AS). Routes are advertised in BGP update messages. BGP is employed when going between different organizational entities since BGP assumes a very limited set of information exchanged between peer agents.

The use of a BGP-based protocol is a good, robust match for semantic routing of example embodiments. Further, data centers are converging to BGP for topology maintenance, including for internal (IGP) purposes, such as Shortest Path First (SPF) routing. Moreover, the BGP-based protocol of example embodiments very cleanly can hide any intent summarization between organizations, and has the ability to summarize multiple IP sub-networks into a single encompassing sub-network for scalability. This allows a range generalization to be passed upstream or, in other words, a smaller set of semantic advertisements can be provided for less granular semantic routes expressed via n-dimensional vector.

The summarized skills or capabilities at a summarizing agent may be calculated by combining multiple intents (or polytopes) in substantially the same manner described above. The smaller set of polytope advertisements provide added value from the perspective of the summarizing agent since the summarizing agent would know the identity of agents capable of answering questions. The summarizer agent owns the responsibility of being able to forward messages to entities capable of answering the question. Billing/accounting may also be abstracted.

A BGP-based protocol is used in an example embodiment to advertise routes to answer specific questions via the range based polytopes. Accordingly, the example embodiment modifies an update message of BGP to carry the polytope ranges representing skills or capabilities of the agents. Conventional BGP advertises reachability topology for remote IP prefixes via Network Layer Reachability Information (NLRI) (e.g., this part of the update message lists IP prefixes that are being advertised by a peer as reachable, etc.). This also allows overlapping reachability to be advertised. An overlap occurs when a set of destinations are within different routes. The BGP update messages are changed from carrying IP address ranges to carrying summarized question (or polytope) ranges of peer agents.

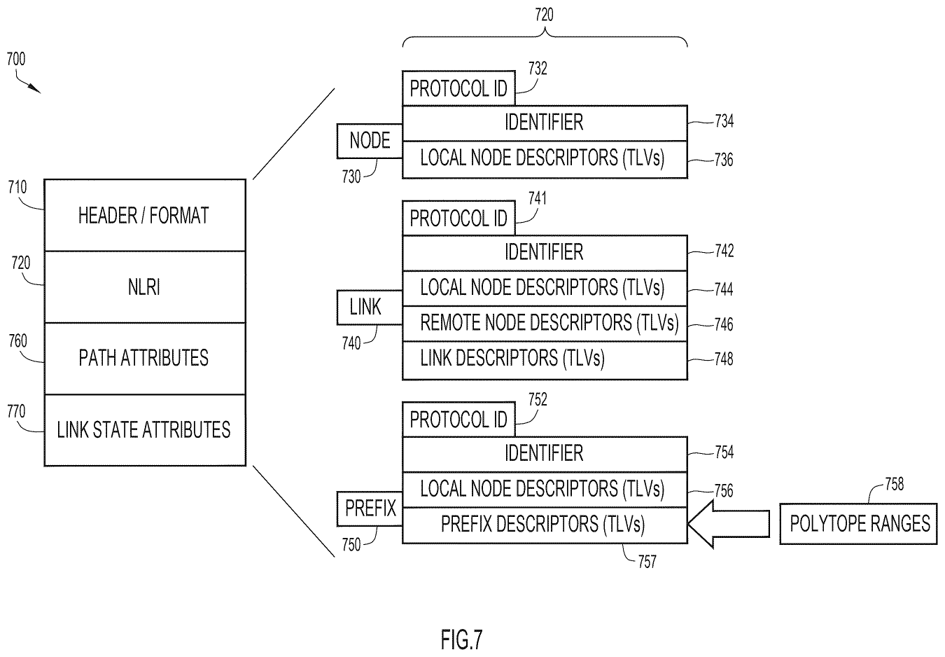

By way of example, the polytope ranges may be included within a modified BGP update message according to an example embodiment. Referring to FIG. 7, an update message 700 for semantic routing includes a protocol header/format section 710, network layer reachability information (NLRI) 720, path attributes 760, and link state attributes 770. Protocol header/format section 710 includes BGP header information and the type or format of the message, while NLRI 720 describes nodes, links, and IP address prefixes. Path attributes 760 include origin and AS-Path attributes for BGP. The origin attribute indicates origin information of a path, while the AS-Path attribute indicates a sequence of autonomous system (AS) path segments. Link state attributes 770 indicate properties of the link, node, and IP address prefixes of NLRI 720. These components are substantially similar to corresponding components of a conventional BGP update message, except that NLRI 720 is modified to include polytope ranges as described below.

NLRI 720 includes a node section 730, a link section 740, and a prefix section 750. Node section 730 includes a protocol identification field 732 to identify the routing protocol, an identifier field 734 to identify a routing domain, and local node descriptors field 736 with information encoded in the format of Type/Length/Value (TLV). This provides node descriptors for a local node anchoring a link. The value includes lower level TLVs for node descriptors. Link section 740 includes a protocol identification field 741 to identify the routing protocol, an identifier field 742 to identify a routing domain, local node descriptors field 744 with information encoded in the TLV format, remote node descriptors field 746 with information encoded in the TLV format, and link descriptors field 748 with information encoded in the TLV format. Local node descriptors field 744 is similar to local node descriptors field 736 described above. Remote node descriptors field 746 provides node descriptors for a remote node anchoring a link. The value includes lower level TLVs for node descriptors. Link descriptors field 748 indicates a link among parallel links between a pair of nodes. The value includes lower level TLVs for link descriptors.

Prefix section 750 includes a protocol identification field 752 to identify the routing protocol, an identifier field 754 to identify the routing domain, local node descriptors field 756 with information encoded in the TLV format, and prefix descriptors field 757 with information encoded in the TLV format. Local node descriptors field 756 is similar to local node descriptors fields 736, 744 described above. Prefix descriptors field 757 identifies a prefix originated by a node. The types for TLVs in node section 730, link section 740, and prefix section 750 are typically predefined in the BGP protocol.

The fields of node section 730, link section 740, and prefix section 750 of NLRI 720 are similar to corresponding sections of a conventional BGP update message. However, in order for the network routing protocol to perform semantic routing, NLRI 720 is modified to accommodate the polytope ranges. This facilitates a BGP-based protocol that can advertise skills or capabilities of agents 110 instead of, or in addition to, advertising IP addresses. In other words, the network routing protocol is modified to include a semantic plane (instead of, or in addition to, a routing plane for IP addresses). By way of example, new or additional TLVs may be added to enable exchange of polytope ranges (e.g., upper/lower ranges for polytope dimensions) within the update message. For example, the polytope TLVs may be employed in prefix descriptors field 757 of prefix section 750 to indicate presence of polytope ranges within the message. Polytope ranges 758 may be stored in the value portion of the prefix descriptors field.

Agents 110 generate and send update messages 700 with the polytope ranges to peer (or neighboring) agents and a corresponding summarizing agent 140 to advertise their skills or capabilities. Summarizing agents 140 generate and send update messages 700 with the summarized polytope ranges to peer (or neighboring) agents and/or other summarizing agents 140 to advertise skills or capabilities of associated target agents 130. The messages may be sent at any desired time intervals (e.g., seconds, minutes, periodically, scheduled times, etc.). An agent 110 (or summarizing agent 140) receiving the update message analyzes prefix descriptors field 757 to identify an update message with polytope ranges and modify routing information (and summaries) accordingly. Agents 110 basically employ a BGP-based network routing protocol that can advertise skills or capabilities of agents instead of, or in addition to, IP addresses.

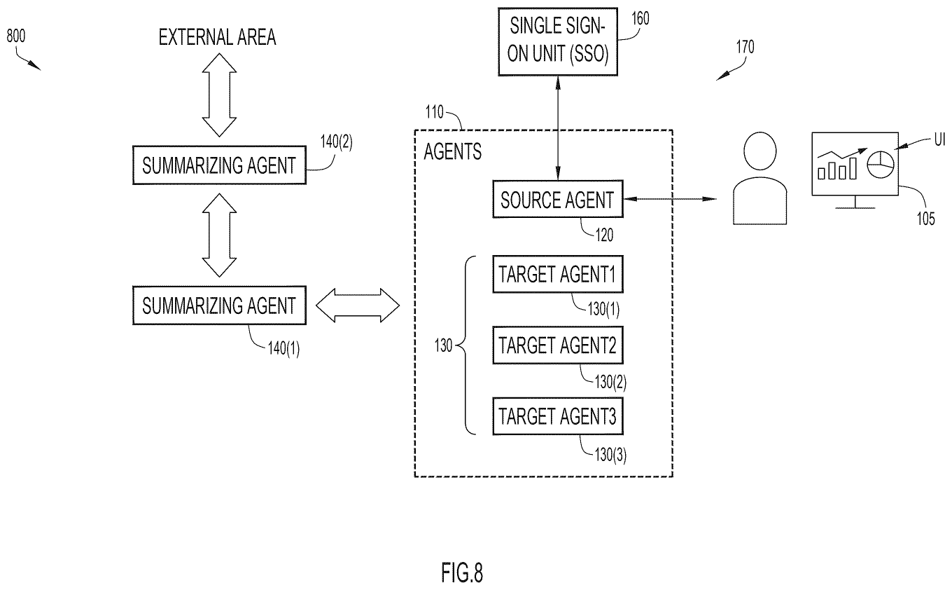

With continued reference to FIGS. 1-7, FIG. 8 illustrates an example network environment 800 in which request routing within a domain may be implemented, according to an example embodiment. Network environment 800 is similar to network environments 100, 600 described above, and includes domain 170 with source agent 120 to receive a request from end-user device 105 of a user, one or more target agents 130 (e.g., 130(1) (TARGET AGENT1), 130(2) (TARGET AGENT2), and 130(3) (TARGET AGENT3) as viewed in FIG. 8)) with skills or capabilities to process certain requests or queries (e.g., certain topics, products, actions, set of commands, etc.), summarizing agents 140(1) and 140(2) for intra-domain routing, and single sign-on unit 160.

Source agent 120 provides a user interface (for end-user device 105) to receive requests and provide results for the request. The request preferably includes text (or audio converted to text), while the results preferably include text (or audio converted from text). Further, source agent 120 verifies the user (e.g., via single sign-on (SSO) unit 160), and analyzes the request for routing decisions (e.g., routing through a summarizing agent 140 or directly to appropriate target agents 130 with sufficient skills or capabilities to process the request). End-user device 105, source agent 120, target agents 130, summarizing agents 140(1), 140(2), and SSO unit 160 may be local to each other and/or communicate over a communication network that may include one or more wide area networks (WANs), such as the Internet, and one or more local area networks (LANs). These components may communicate with each other over the communication network using a variety of known or hereafter developed communication protocols.

Source agent 120 and target agents 130 advertise their skills or capabilities to neighboring target agents 130 and summarizing agent 140(1). Summarizing agent 140(1) may combine or summarize the skills or capabilities from the source and target agents, and advertise the summary outside of domain 170 to peer (or neighboring) agents in substantially the same manner described above. This enables the summarizing agent to hide source agent 120 and target agents 130 from devices outside of the domain. In the case of intra-domain routing, summarizing agent 140(1), 140(2) may serve as routers to route requests between agents 110 of domain 170 (e.g., source agent 120 and target agents 130 associated with the summarizing agents 140(1), 140(2)). Domain 170 may be partitioned into areas, where summarizing agent 140(2) is associated with target agents of an area within domain 170 external of an area of summarizing agent 140(1).

Source agent 120 may receive a request from end-user device 105. Semantic router 112 of source agent 120 analyzes the request to render routing decisions. By way of example, semantic router 112 may determine that one or more target agents 130 within domain 170 have sufficient skills or capabilities to process the request based on a comparison of a request embedding to polytope ranges of the target agents in substantially the same manner described above. In this case, semantic router 112 routes the request from source agent 120 to the determined target agents 130 (e.g., either directly or through summarizing agent 140(1)) for processing. The determined target agents process the request (e.g., via their corresponding LLMs 116 in substantially the same manner described above) and return results to source agent 120. The source agent combines the results from the target agents and provides an overall result to end-user device 105.

Agents 110 dynamically advertise their skills or capabilities with peer (or neighboring) agents of a domain and/or a corresponding summarizing agent 140. This may be accomplished by the BGP-based network routing protocol (internal BGP-based routing protocol) in substantially the same manner described above. However, various other network routing protocols may be employed (e.g., Open Shortest Path First (OSPF), Interior Gateway Protocol (IGP), Intermediate System to Intermediate System, etc.) and modified or adapted for semantic routing. These network routing protocols have different strengths and weaknesses.

For example, OSPF and Intermediate System to Intermediate System network routing protocols are other link state routing protocols that are used within an organization, and across a limited set of trusted devices. This smaller set of devices allows for faster incremental alignment of routes between devices. Further, failover can occur in less that a second when a device fails, rather than tens of seconds occurring with BGP. In addition, these network routing protocols can refresh their entire link state database periodically (e.g., every 15 or 30 minutes).

An OSPF-based network routing protocol may be more applicable to use than a BGP-based network routing protocol when there is a more limited set of intents and agents accessible via a small set of peers in a single organization (or domain). Briefly, the conventional OSPF network routing protocol stores network topology information in a database (e.g., Link State Database (LSDB)) that stores information from Link State Advertisements (LSAs) of routers. Each router exchanges LSAs with neighboring routers. Received LSAs are used to update the corresponding LSDB. A Shortest Path First (SPF) algorithm is used to determine the shortest path to each network. In order to synchronize LSDBs, a router initially performs neighbor discovery and commences exchanging Database Description (DBD) packets including information of a corresponding LSDB (e.g., LSAs and corresponding sequence numbers). When a router identifies a missing LSA, a Link State Request (LSR) packet is sent to request the missing LSA, and a Link State Update (LSU) packet is returned containing the missing LSA. A Link State Acknowledgment (LSAck) packet is sent when an LSU is received. This synchronizes the LDSBs to provide a consistent view of network topology.

In an example embodiment, each intent that is supported is encoded as low-high values (of polytopes) within n-dimensional vectors as described above. Neighboring peer agents employ an LSDB-based database to store intents (or polytope ranges) and an OSPF-based database exchange process to compare intents supported using OSPF Database Description (DBD) packets modified to indicate LSAs for semantic routing. This would allow a set of trusted peer agents to identify missing items (polytope ranges) from each other's databases and subsequently exchange the necessary question information to synchronize the questions supported on either side.

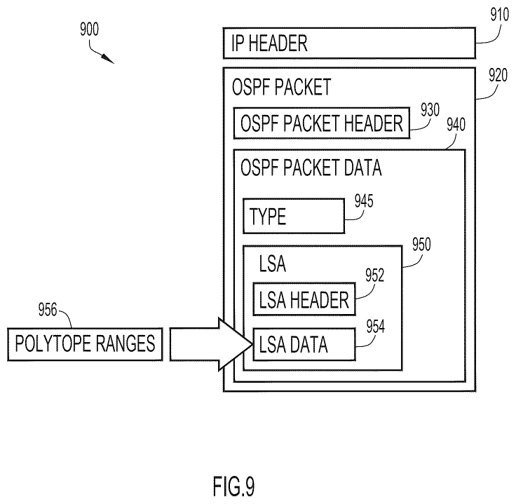

The individual intents supported by a specific agent is described by an OSPF-based or modified LSA indicating each intent supported via n-dimensional vector (or polytope) ranges associated with an OSPF stub network (e.g., having a single router (or entry/exit), etc.). By way of example, the polytope ranges may be included within an OSPF-based packet according to an example embodiment. Referring to FIG. 9, an OSPF-based packet 900 for semantic routing includes a protocol header 910 and an OSPF packet 920 including an OSPF packet header 930 and OSPF packet data 940. OSPF packet data 940 includes packet type specific data 945 and one or more LSAs 950. Each LSA 950 includes an LSA header 952 and LSA data 954. LSA header 952 may include an age, options to control handling of the LSA, an LSA type, an LSA identifier, router advertising the LSA, a sequence number used to identify newer copies, and a checksum. These components are substantially similar to corresponding components of a conventional OSPF packet, except that LSA data 954 is modified to include polytope ranges 956.

Agents 110 generate and exchange packets 900 including the polytope ranges to peer (or neighboring) agents and corresponding summarizing agent 140(1) to advertise their skills or capabilities. Summarizing agents 140(1), 140(2) may generate and exchange packets 900 with the polytope ranges of associated agents to advertise skills or capabilities of associated target agents 130 in the respective areas. Packets 900 may be exchanged at any desired time interval (e.g., second, minute, periodically, at scheduled times, etc.). An agent 110 or summarizing agent 140(1), 140(2) receiving packet 900 analyzes LSA data 954 to identify a packet with polytope ranges and modify routing information accordingly (e.g., routing table, LSDB, etc.). Agents 110 basically employ an OSPF-based network routing protocol that can advertise skills or capabilities of agents instead of, or in addition to, IP addresses.

In addition, an example embodiment may employ plural network routing protocols. A mix of BGP, OSPF, and other network routing protocol mechanisms may be employed to interchange polytope information at protocol peering points. This enables mixing of the strengths of the network routing protocols. For example, a first (e.g., BGP-based, etc.) protocol may be employed for inter-domain routing (between domains 170, 180, 190), while a second (e.g., OSPF-based, Intermediate System to Intermediate System-based, IGP-based, etc.) protocol may be used for intra-domain routing (within a domain 170, 180, 190) in substantially the same manners described above.

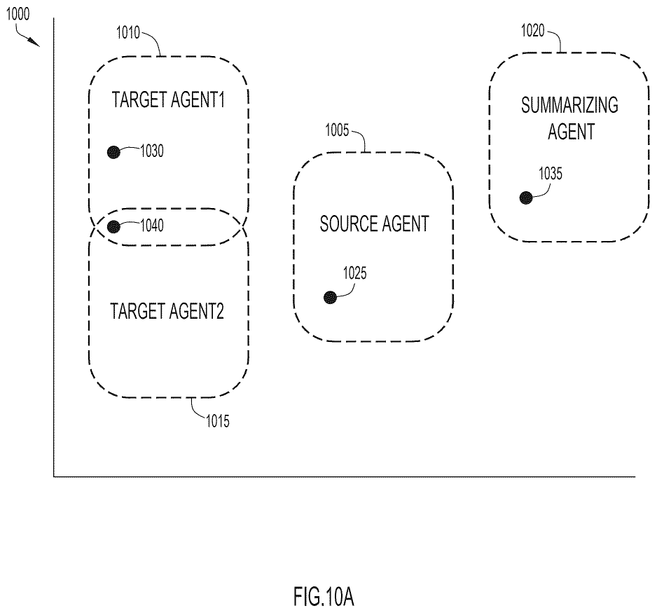

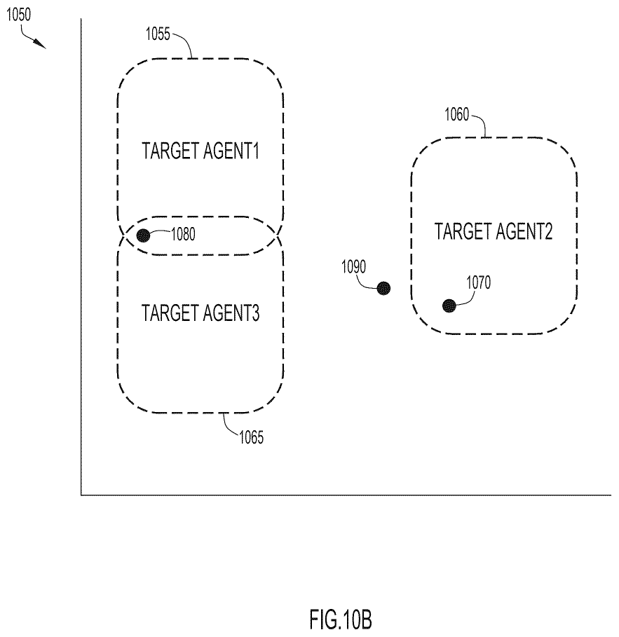

With continued reference to FIGS. 1-9, FIG. 10A illustrates an example vector space 1000 for a source agent 120 for determining agents to process requests, according to an example embodiment. Initially, vector space 1000 includes dimensions corresponding to the dimensions of embeddings of requests and agent intents and contexts. The collective (intent, context) embeddings of source agent 120 (e.g., SOURCE AGENT as viewed in FIG. 10A), each target agent 130 (e.g., TARGET AGENT1 and TARGET AGENT2 as viewed in FIG. 10A), and summarizing agent 140 (e.g., SUMMARIZING AGENT as viewed in FIG. 10A) occupy a corresponding discrete region in the vector space. By way of example, vector space 1000 includes a region 1005 corresponding to source agent 120, a region 1010 corresponding to TARGET AGENT1 advertising to source agent 120, a region 1015 corresponding to TARGET AGENT2 advertising to source agent 120, and a region 1020 corresponding to the SUMMARIZING AGENT associated with source agent 120. Accordingly, each region 1005, 1010, 1015 defines the entire set of skills or capabilities (e.g., intents, contexts, etc.) for the corresponding agent and, thus, represents the boundary of the agent skills or capabilities. Region 1020 defines the entire set of skills or capabilities (e.g., intents, contexts, etc.) for the target agents associated with the summarizing agent and, thus, represents the boundary of the skills or capabilities of the associated target agents. However, the vector space may include any quantity of regions for any quantity of agents 110.

Source agent 120 may receive a request and determine an embedding 1025 of the request (intent and context) mapped to vector space 1000 in substantially the same manner described above. Semantic router 112 of source agent 120 identifies region 1005 that encompasses or contains embedding 1025 of the request (based on a comparison of the request embedding to boundaries of regions 1010, 1015, 1020 of vector space 1000 provided during skills advertisement and to boundaries of region 1005 known to the source agent) in substantially the same manner described above. Since region 1005 corresponds to source agent 120, the source agent may process the request to produce results in substantially the same manner described above.

Source agent 120 may receive another request and determine an embedding 1030 of the request (intent and context) mapped to vector space 1000 in substantially the same manner described above. Semantic router 112 of the source agent identifies region 1010 that encompasses or contains embedding 1030 of the request (based on a comparison of the request embedding to boundaries of regions 1010, 1015, 1020 of vector space 1000 provided during skills advertisement and to boundaries of region 1005 known to the source agent). Since region 1010 corresponds to TARGET AGENT1, semantic router 112 of source agent 120 routes or sends the request to TARGET AGENT1 to process the request (e.g., via corresponding LLM 116) in substantially the same manner described above. The results of the request from TARGET AGENT1 are returned to source agent 120 to provide results for the request in substantially the same manner described above.

Source agent 120 may receive yet another request and determine an embedding 1035 of the request (intent and context) mapped to vector space 1000 in substantially the same manner described above. Semantic router 112 of the source agent identifies region 1020 that encompasses or contains embedding 1035 of the request (based on a comparison of the request embedding to boundaries of regions 1010, 1015, 1020 of vector space 1000 provided during skills advertisement and to boundaries of region 1005 known to the source agent). Since region 1020 corresponds to the SUMMARIZING AGENT, semantic router 112 of source agent 120 routes or sends the request to the SUMMARIZING AGENT to process the request in substantially the same manner described above. The results of the request from the SUMMARIZING AGENT (via an associated target agent) are returned to source agent 120 to provide results for the request in substantially the same manner described above.

Source agent 120 may receive still another request and determine an embedding 1040 of the request (intent and context) mapped to vector space 1000 in substantially the same manner described above. Semantic router 112 of source agent 120 identifies regions 1010 and 1015 that each encompass or contain embedding 1040 of the request (based on a comparison of the request embedding to boundaries of regions 1010, 1015, 1020 of vector space 1000 provided during skills advertisement and to boundaries of region 1005 known to the source agent) in substantially the same manner described above. Since regions 1010, 1015 correspond to TARGET AGENT1 and TARGET AGENT2, semantic router 112 of source agent 120 routes or sends the request to TARGET AGENT1 and TARGET AGENT2 to process the request (e.g., via corresponding LLMs 116) in substantially the same manner described above. The results of the request from TARGET AGENT1 and TARGET AGENT2 are returned to source agent 120 to provide results for the request in substantially the same manner described above.

In the event that the embedding of a request resides in region 1020 of vector space 1000 (e.g., corresponding to a summarizing agent 140), the request is routed or sent by semantic router 112 of source agent 120 to summarizing agent 140. The summarizing agent identifies one or more associated target agents 130 to process the request. With continued reference to FIG. 1-9 and 10A, FIG. 10B illustrates an example vector space 1050 for summarizing agent 140 for determining agents to process requests, according to an example embodiment. Initially, vector space 1050 includes dimensions corresponding to the dimensions of embeddings of requests and agent intents and contexts. The collective (intent, context) embeddings of each target agent 130 (e.g., TARGET AGENT1, TARGET AGENT2, and TARGET AGENT3 as viewed in FIG. 10B) occupy a corresponding discrete region in the vector space. By way of example, vector space 1050 includes a region 1055 corresponding to TARGET AGENT1, a region 1060 corresponding to TARGET AGENT2, and a region 1065 corresponding to TARGET AGENT3. Accordingly, each region 1055, 1060, 1065 defines the entire set of skills or capabilities (e.g., intents, contexts, etc.) for the corresponding agent and, thus, represents the boundary of the agent skills or capabilities. However, the vector space may include any quantity of regions for any quantity of agents 110.

Summarizing agent 140 may receive a request from a source agent 120 and determine an embedding 1070 of the request (intent and context) mapped to vector space 1050 in substantially the same manner described above. Summarizing agent 140 identifies region 1060 that encompasses or contains embedding 1070 of the request (based on a comparison of the request embedding to boundaries of the regions of vector space 1050 provided during skills advertisement) in substantially the same manner described above. Since region 1060 corresponds to TARGET AGENT2, summarizing agent 140 sends the request to TARGET AGENT2 to process the request (e.g., via corresponding LLM 116) in substantially the same manner described above. The results of the request from TARGET AGENT2 are returned to source agent 120 (via summarizing agent 140) to produce results for the request in substantially the same manner described above.

Summarizing agent 140 may receive another request from source agent 120 and determine an embedding 1080 of the request (intent and context) mapped to vector space 1050 in substantially the same manner described above. The summarizing agent identifies regions 1055 and 1065 that each encompass or contain embedding 1080 of the request (based on a comparison of the request embedding to boundaries of the regions of vector space 1050 provided during skills advertisement) in substantially the same manner described above. Since regions 1055, 1065 correspond to TARGET AGENT1 and TARGET AGENT3, summarizing agent 140 routes the request to TARGET AGENT1 and TARGET AGENT3 to process the request (e.g., via corresponding LLMs 116) in substantially the same manner described above. The results of the request from TARGET AGENT1 and TARGET AGENT3 are returned to source agent 120 (via summarizing agent 140) to produce results for the request in substantially the same manner described above.

Summarizing agent 140 may receive yet another request from source agent 120 and determine an embedding 1090 of the request (intent and context) mapped to vector space 1050 in substantially the same manner described above. Since embedding 1090 resides outside regions 1055, 1060, 1065 of vector space 1050, summarizing agent 140 is unable to initially identify a target agent to process the request (based on a comparison of the request embedding to boundaries of the regions of vector space 1050 provided during skills advertisement). In this case, summarizing agent 140 identifies a closest or nearest region to embedding 1090. This may be determined based on a shortest distance in vector space 1050 between embedding 1090 and one or more boundaries of regions 1055, 1060, 1065 using any conventional or other techniques (e.g., Euclidean or other distance metrics, cosine similarity, etc.) in substantially the same manner described above.

By way of example, embedding 1090 may be closest to region 1060 (e.g., as viewed in FIG. 10B). Since region 1060 corresponds to TARGET AGENT2, summarizing agent 140 routes the request to TARGET AGENT2 to process the request (e.g., via corresponding LLM 116) in substantially the same manner described above. The results of the request from TARGET AGENT2 are returned to source agent 120 (via summarizing agent 140) to produce results for the request in substantially the same manner described above.

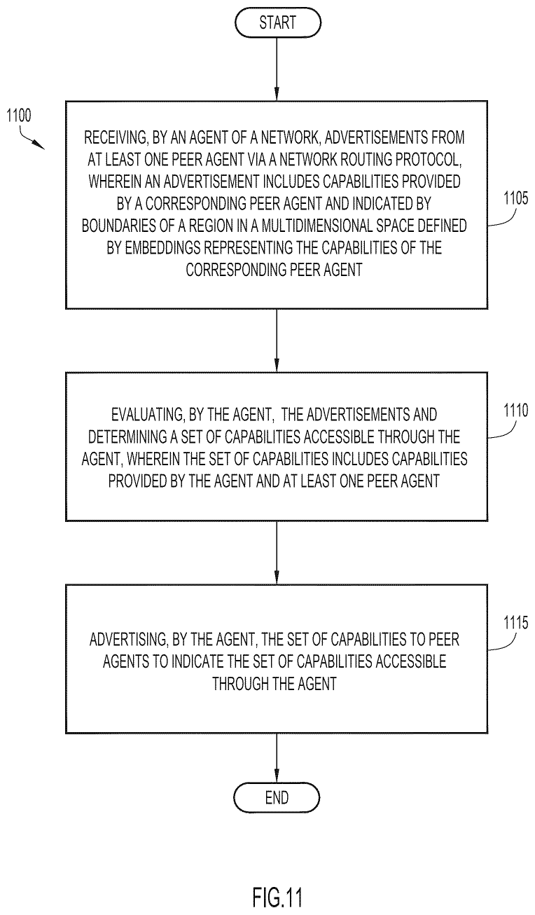

FIG. 11 is a flowchart of an example method 1100 for routing requests to corresponding agents, according to an example embodiment. At operation 1105, an agent of a network receives advertisements from at least one peer agent via a network routing protocol. An advertisement includes capabilities provided by a corresponding peer agent and indicated by boundaries of a region in a multidimensional space defined by embeddings representing the capabilities of the corresponding peer agent. At operation 1110, the agent evaluates the advertisements and determines a set of capabilities accessible through the agent. The set of capabilities includes capabilities provided by the agent and at least one peer agent. At operation 1115, the agent advertises the set of capabilities to peer agents to indicate the set of capabilities accessible through the agent.

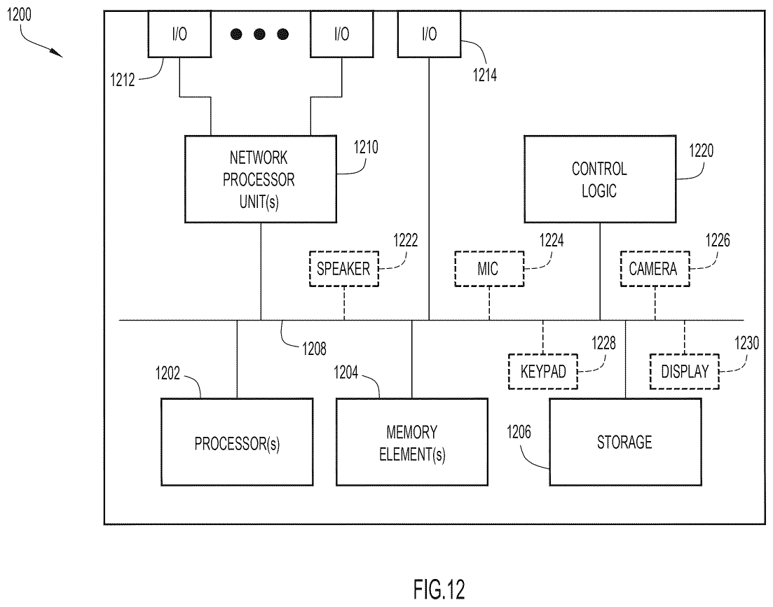

Referring to FIG. 12, FIG. 12 illustrates a hardware block diagram of a computing device 1200 that may perform functions associated with operations discussed herein in connection with the techniques depicted in FIG. 1-9, 10A, 10B, and 11. In various embodiments, a computing device or apparatus or system, such as computing device 1200 or any combination of computing devices 1200, may be configured as any device entity/entities (e.g., network nodes, computer devices, end-user devices, client devices, communication devices, network devices, processors, switching devices, network interfaces, agents, routers, etc.) as discussed for the techniques depicted in connection with FIG. 1-9, 10A, 10B, and 11 in order to perform operations of the various techniques discussed herein.

In at least one embodiment, computing device 1200 may be any apparatus that may include one or more processor(s) 1202, one or more memory element(s) 1204, storage 1206, a bus 1208, one or more network processor unit(s) 1210 interconnected with one or more network input/output (I/O) interface(s) 1212, one or more I/O interface(s) 1214, and control logic 1220. In various embodiments, instructions associated with logic for computing device 1200 can overlap in any manner and are not limited to the specific allocation of instructions and/or operations described herein.

In at least one embodiment, processor(s) 1202 is/are at least one hardware processor configured to execute various tasks, operations and/or functions for computing device 1200 as described herein according to software and/or instructions configured for computing device 1200. Processor(s) 1202 (e.g., a hardware processor) can execute any type of instructions associated with data to achieve the operations detailed herein. In one example, processor(s) 1202 can transform an element or an article (e.g., data, information) from one state or thing to another state or thing. Any of potential processing elements, microprocessors, digital signal processor, baseband signal processor, modem, PHY, controllers, systems, managers, logic, and/or machines described herein can be construed as being encompassed within the broad term ‘processor’.

In at least one embodiment, memory element(s) 1204 and/or storage 1206 is/are configured to store data, information, software, and/or instructions associated with computing device 1200, and/or logic configured for memory element(s) 1204 and/or storage 1206. For example, any logic described herein (e.g., control logic 1220) can, in various embodiments, be stored for computing device 1200 using any combination of memory element(s) 1204 and/or storage 1206. Note that in some embodiments, storage 1206 can be consolidated with memory elements 1204 (or vice versa), or can overlap/exist in any other suitable manner.

In at least one embodiment, bus 1208 can be configured as an interface that enables one or more elements of computing device 1200 to communicate in order to exchange information and/or data. Bus 1208 can be implemented with any architecture designed for passing control, data and/or information between processors, memory elements/storage, peripheral devices, and/or any other hardware and/or software components that may be configured for computing device 1200. In at least one embodiment, bus 1208 may be implemented as a fast kernel-hosted interconnect, potentially using shared memory between processes (e.g., logic), which can enable efficient communication paths between the processes.

In various embodiments, network processor unit(s) 1210 may enable communication between computing device 1200 and other systems, entities, etc., via network I/O interface(s) 1212 to facilitate operations discussed for various embodiments described herein. In various embodiments, network processor unit(s) 1210 can be configured as a combination of hardware and/or software, such as one or more Ethernet driver(s) and/or controller(s) or interface cards, Fibre Channel (e.g., optical) driver(s) and/or controller(s), wireless receivers/transmitters/transceivers, baseband processor(s)/modem(s), and/or other similar network interface driver(s) and/or controller(s) now known or hereafter developed to enable communications between computing device 1200 and other systems, entities, etc. to facilitate operations for various embodiments described herein. In various embodiments, network I/O interface(s) 1212 can be configured as one or more Ethernet port(s), Fibre Channel ports, any other I/O port(s), and/or antenna(s)/antenna array(s) now known or hereafter developed. Thus, the network processor unit(s) 1210 and/or network I/O interfaces 1212 may include suitable interfaces for receiving, transmitting, and/or otherwise communicating data and/or information in a network environment.

I/O interface(s) 1214 allow for input and output of data and/or information with other entities that may be connected to computing device 1200. For example, I/O interface(s) 1214 may provide a connection to external devices such as a keyboard, keypad, a touch screen, and/or any other suitable input device now known or hereafter developed. In some instances, external devices can also include portable computer readable (non-transitory) storage media such as database systems, thumb drives, portable optical or magnetic disks, and memory cards. In still some instances, external devices can be a mechanism to display data to a user, such as, for example, a computer monitor, a display screen, or the like.

With respect to certain entities (e.g., client device, end-user device, network device, network nodes, processors, network interfaces, switching devices, agents, servers, routers, etc.), computing device 1200 may further include, or be coupled to, a speaker 1222 to convey sound, microphone or other sound sensing device 1224, camera or image capture device 1226, a keypad or keyboard 1228 to enter information (e.g., alphanumeric information, etc.), and/or a touch screen or other display 1230. These items may be coupled to bus 1208 or I/O interface(s) 1214 to transfer data with other elements of computing device 1200.

In various embodiments, control logic 1220 can include instructions that, when executed, cause processor(s) 1202 to perform operations, which can include, but not be limited to, providing overall control operations of computing device 1200; interacting with other entities, systems, etc. described herein; maintaining and/or interacting with stored data, information, parameters, etc. (e.g., memory element(s), storage, data structures, databases, tables, etc.); combinations thereof; and/or the like to facilitate various operations for embodiments described herein.

Present embodiments may provide various technical and other advantages. In an embodiment, network routing is performed to direct a request to appropriate agents for processing based on semantic correlation of a request intent to agent skills or capabilities which increases throughput and performance for handling requests and avoids re-routing and re-processing of requests. This also reduces consumption of processing and memory/storage resources to improve computing performance and network routing.

In an embodiment, the machine learning models (and/or LLM prompts) may be continuously updated (or trained) based on feedback related to results of the agents. For example, an agent may return a poor result (e.g., based on various metrics, etc.). The feedback may be used to update or train the machine learning models (or LLM prompts) to decrease the confidence of that response, and/or to avoid routing to that agent for similar requests. A similar approach may be used for a good result, where the feedback may be used to update or train the machine learning models (or LLM prompts) to increase the confidence of that response, and/or increase routing to that agent for similar requests. Thus, the machine learning models (or LLM prompts) may continuously evolve (or be trained) to learn to produce appropriate responses, and/or routing may be updated as requests are processed.

The programs described herein (e.g., control logic 1220) may be identified based upon application(s) for which they are implemented in a specific embodiment. However, it should be appreciated that any particular program nomenclature herein is used merely for convenience; thus, embodiments herein should not be limited to use(s) solely described in any specific application(s) identified and/or implied by such nomenclature.

Data relating to operations described herein may be stored within any conventional or other data structures (e.g., files, arrays, lists, stacks, queues, records, etc.) and may be stored in any desired storage unit (e.g., database, data or other stores or repositories, queue, etc.). The data transmitted between device entities may include any desired format and arrangement, and may include any quantity of any types of fields of any size to store the data. The definition and data model for any datasets may indicate the overall structure in any desired fashion (e.g., computer-related languages, graphical representation, listing, etc.).

The present embodiments may employ any number of any type of user interface (e.g., graphical user interface (GUI), command-line, prompt, etc.) for obtaining or providing information, where the interface may include any information arranged in any fashion. The interface may include any number of any types of input or actuation mechanisms (e.g., buttons, icons, fields, boxes, links, etc.) disposed at any locations to enter/display information and initiate desired actions via any suitable input devices (e.g., mouse, keyboard, etc.). The interface screens may include any suitable actuators (e.g., links, tabs, etc.) to navigate between the screens in any fashion.

The environment of the present embodiments may include any number of computer or other processing systems (e.g., client or end-user systems, server systems, network devices, storage devices, etc.) and databases or other repositories arranged in any desired fashion, where the present embodiments may be applied to any desired type of computing environment (e.g., cloud computing, client-server, network computing, mainframe, stand-alone systems, datacenters, etc.). The computer or other processing systems employed by the present embodiments may be implemented by any number of any personal or other type of computer or processing system (e.g., desktop, laptop, Personal Digital Assistant (PDA), mobile devices, etc.), and may include any commercially available operating system and any combination of commercially available and custom software. These systems may include any types of monitors and input devices (e.g., keyboard, mouse, voice recognition, etc.) to enter and/or view information.

It is to be understood that the software of the present embodiments may be implemented in any desired computer language and could be developed by one of ordinary skill in the computer arts based on the functional descriptions contained in the specification and flowcharts and diagrams illustrated in the drawings. Further, any references herein of software performing various functions generally refer to computer systems or processors performing those functions under software control. The computer systems of the present embodiments may alternatively be implemented by any type of hardware and/or other processing circuitry.

The various functions of the computer or other processing systems may be distributed in any manner among any number of software and/or hardware modules or units, processing or computer systems and/or circuitry, where the computer or processing systems may be disposed locally or remotely of each other and communicate via any suitable communications medium (e.g., Local Area Network (LAN), Wide Area Network (WAN), Intranet, Internet, hardwire, modem connection, wireless, etc.). For example, the functions of the present embodiments may be distributed in any manner among the various network devices, storage devices, and other processing devices or systems, and/or any other intermediary processing devices. The software and/or algorithms described above and illustrated in the flowcharts and diagrams may be modified in any manner that accomplishes the functions described herein. In addition, the functions in the flowcharts, diagrams, or description may be performed in any order that accomplishes a desired operation.

The networks of present embodiments may be implemented by any number of any type of communications network (e.g., LAN, WAN, Internet, Intranet, Virtual Private Network (VPN), etc.). The computer or other processing systems of the present embodiments may include any conventional or other communications devices to communicate over the network via any conventional or other protocols. The computer or other processing systems may utilize any type of connection (e.g., wired, wireless, etc.) for access to the network. Local communication media may be implemented by any suitable communication media (e.g., LAN, hardwire, wireless link, Intranet, etc.).

Each of the elements described herein may couple to and/or interact with one another through interfaces and/or through any other suitable connection (wired or wireless) that provides a viable pathway for communications. Interconnections, interfaces, and variations thereof discussed herein may be utilized to provide connections among elements in a system and/or may be utilized to provide communications, interactions, operations, etc. among elements that may be directly or indirectly connected in the system. Any combination of interfaces can be provided for elements described herein in order to facilitate operations as discussed for various embodiments described herein.

In various embodiments, any device entity or apparatus as described herein may store data/information in any suitable volatile and/or non-volatile memory item (e.g., magnetic hard disk drive, solid state hard drive, semiconductor storage device, Random Access Memory (RAM), Read Only Memory (ROM), Erasable Programmable ROM (EPROM), application specific integrated circuit (ASIC), etc.), software, logic (fixed logic, hardware logic, programmable logic, analog logic, digital logic), hardware, and/or in any other suitable component, device, element, and/or object as may be appropriate. Any of the memory items discussed herein should be construed as being encompassed within the broad term ‘memory element’. Data/information being tracked and/or sent to one or more device entities as discussed herein could be provided in any database, table, register, list, cache, storage, and/or storage structure: all of which can be referenced at any suitable timeframe. Any such storage options may also be included within the broad term ‘memory element’as used herein.

Note that in certain example implementations, operations as set forth herein may be implemented by logic encoded in one or more tangible media that is capable of storing instructions and/or digital information and may be inclusive of non-transitory tangible media and/or non-transitory computer readable storage media (e.g., embedded logic provided in: an ASIC, Digital Signal Processing (DSP) instructions, software [potentially inclusive of object code and source code], etc.) for execution by one or more processor(s), and/or other similar machine, etc. Generally, memory element(s) 1204 and/or storage 1206 can store data, software, code, instructions (e.g., processor instructions), logic, parameters, combinations thereof, and/or the like used for operations described herein. This includes memory elements 1204 and/or storage 1206 being able to store data, software, code, instructions (e.g., processor instructions), logic, parameters, combinations thereof, or the like that are executed to carry out operations in accordance with teachings of the present disclosure.

In some instances, software of the present embodiments may be available via a non-transitory computer useable medium (e.g., magnetic or optical mediums, magneto-optic mediums, Compact Disc ROM (CD-ROM), Digital Versatile Disc (DVD), memory devices, etc.) of a stationary or portable program product apparatus, downloadable file(s), file wrapper(s), object(s), package(s), container(s), and/or the like. In some instances, non-transitory computer readable storage media may also be removable. For example, a removable hard drive may be used for memory/storage in some implementations. Other examples may include optical and magnetic disks, thumb drives, and smart cards that can be inserted and/or otherwise connected to a computing device for transfer onto another computer readable storage medium.

### Variations and Implementations

Embodiments described herein may include one or more networks, which can represent a series of points and/or network elements of interconnected communication paths for receiving and/or transmitting messages (e.g., packets of information) that propagate through the one or more networks. These network elements offer communicative interfaces that facilitate communications between the network elements. A network can include any number of hardware and/or software elements coupled to (and in communication with) each other through a communication medium. Such networks can include, but are not limited to, any Local Area Network (LAN), Virtual LAN (VLAN), Wide Area Network (WAN) (e.g., the Internet), Software Defined WAN (SD-WAN), Wireless Local Area (WLA) access network, Wireless Wide Area (WWA) access network, Metropolitan Area Network (MAN), Intranet, Extranet, Virtual Private Network (VPN), Low Power Network (LPN), Low Power Wide Area Network (LPWAN), Machine to Machine (M2M) network, Internet of Things (IoT) network, Ethernet network/switching system, any other appropriate architecture and/or system that facilitates communications in a network environment, and/or any suitable combination thereof.

Networks through which communications propagate can use any suitable technologies for communications including wireless communications (e.g., 4G/5G/nG, IEEE 802.11 (e.g., Wi-Fi®/Wi-Fi6®), IEEE 802.16 (e.g., Worldwide Interoperability for Microwave Access (WiMAX)), Radio-Frequency Identification (RFID), Near Field Communication (NFC), Bluetooth™, mm. wave, Ultra-Wideband (UWB), etc.), and/or wired communications (e.g., T1 lines, T3 lines, digital subscriber lines (DSL), Ethernet, Fibre Channel, etc.). Generally, any suitable means of communications may be used such as electric, sound, light, infrared, and/or radio to facilitate communications through one or more networks in accordance with embodiments herein. Communications, interactions, operations, etc. as discussed for various embodiments described herein may be performed among entities that may be directly or indirectly connected utilizing any algorithms, communication protocols, interfaces, etc. (proprietary and/or non-proprietary) that allow for the exchange of data and/or information.

In various example implementations, any device entity or apparatus for various embodiments described herein can encompass network elements (which can include virtualized network elements, functions, etc.) such as, for example, network appliances, forwarders, routers, servers, switches, gateways, bridges, load-balancers, firewalls, processors, modules, radio receivers/transmitters, or any other suitable device, component, element, or object operable to exchange information that facilitates or otherwise helps to facilitate various operations in a network environment as described for various embodiments herein. Note that with the examples provided herein, interaction may be described in terms of one, two, three, or four device entities. However, this has been done for purposes of clarity, simplicity and example only. The examples provided should not limit the scope or inhibit the broad teachings of systems, networks, etc. described herein as potentially applied to a myriad of other architectures.

Communications in a network environment can be referred to herein as ‘messages’, ‘messaging’, ‘signaling’, ‘data’, ‘content’, ‘objects’, ‘requests’, ‘queries’, ‘responses’, ‘replies’, etc. which may be inclusive of packets. As referred to herein and in the claims, the term ‘packet’ or ‘frame’ may be used in a generic sense to include packets, frames, segments, datagrams, and/or any other generic units that may be used to transmit communications in a network environment. Generally, a packet is a formatted unit of data that can contain control or routing information (e.g., source and destination address, source and destination port, etc.) and data, which is also sometimes referred to as a ‘payload’, ‘data payload’, and variations thereof. In some embodiments, control or routing information, management information, or the like can be included in packet fields, such as within header(s) and/or trailer(s) of packets. Internet Protocol (IP) addresses discussed herein and in the claims can include any IP version 4 (IPv4) and/or IP version 6 (IPv6) addresses.

To the extent that embodiments presented herein relate to the storage of data, the embodiments may employ any number of any conventional or other databases, data stores or storage structures (e.g., files, databases, data structures, data or other repositories, etc.) to store information.

Note that in this Specification, references to various features (e.g., elements, structures, nodes, modules, components, engines, logic, steps, operations, functions, characteristics, etc.) included in ‘one embodiment’, ‘example embodiment’, ‘an embodiment’, ‘another embodiment’, ‘certain embodiments’, ‘some embodiments’, ‘various embodiments’, ‘other embodiments’, ‘alternative embodiment’, and the like are intended to mean that any such features are included in one or more embodiments of the present disclosure, but may or may not necessarily be combined in the same embodiments. Note also that a module, engine, client, controller, function, logic or the like as used herein in this Specification, can be inclusive of an executable file comprising instructions that can be understood and processed on a server, computer, processor, machine, compute node, combinations thereof, or the like and may further include library modules loaded during execution, object files, system files, hardware logic, software logic, or any other executable modules.

It is also noted that the operations and steps described with reference to the preceding figures illustrate only some of the possible scenarios that may be executed by one or more device entities discussed herein. Some of these operations may be deleted or removed where appropriate, or these steps may be modified or changed considerably without departing from the scope of the presented concepts. In addition, the timing and sequence of these operations may be altered considerably and still achieve the results taught in this disclosure. The preceding operational flows have been offered for purposes of example and discussion. Substantial flexibility is provided by the embodiments in that any suitable arrangements, chronologies, configurations, and timing mechanisms may be provided without departing from the teachings of the discussed concepts.

As used herein, unless expressly stated to the contrary, use of the phrase ‘at least one of’, ‘one or more of’, ‘and/or’, variations thereof, or the like are open-ended expressions that are both conjunctive and disjunctive in operation for any and all possible combinations of the associated listed items. For example, each of the expressions ‘at least one of X, Y and Z’, ‘at least one of X, Y or Z’, ‘one or more of X, Y and Z’, ‘one or more of X, Y or Z’ and ‘X, Y and/or Z’ can mean any of the following: 1) X, but not Y and not Z; 2) Y, but not X and not Z; 3) Z, but not X and not Y; 4) X and Y, but not Z; 5) X and Z, but not Y; 6) Y and Z, but not X; or 7) X, Y, and Z.

Each example embodiment disclosed herein has been included to present one or more different features. However, all disclosed example embodiments are designed to work together as part of a single larger system or method. This disclosure explicitly envisions compound embodiments that combine multiple previously discussed features in different example embodiments into a single system or method.

Additionally, unless expressly stated to the contrary, the terms ‘first’, ‘second’, ‘third’, etc., are intended to distinguish the particular nouns they modify (e.g., element, condition, node, module, activity, operation, etc.). Unless expressly stated to the contrary, the use of these terms is not intended to indicate any type of order, rank, importance, temporal sequence, or hierarchy of the modified noun. For example, ‘first X’ and ‘second X’ are intended to designate two ‘X’ elements that are not necessarily limited by any order, rank, importance, temporal sequence, or hierarchy of the two elements. Further as referred to herein, ‘at least one of’ and ‘one or more of’ can be represented using the ‘(s)’nomenclature (e.g., one or more element(s)).

One or more advantages described herein are not meant to suggest that any one of the embodiments described herein necessarily provides all of the described advantages or that all the embodiments of the present disclosure necessarily provide any one of the described advantages. Numerous other changes, substitutions, variations, alterations, and/or modifications may be ascertained to one skilled in the art and it is intended that the present disclosure encompass all such changes, substitutions, variations, alterations, and/or modifications as falling within the scope of the appended claims.

In one form, a method is provided. The method comprises: receiving, by an agent of a network, advertisements from at least one peer agent via a network routing protocol, wherein an advertisement includes capabilities provided by a corresponding peer agent and indicated by boundaries of a region in a multidimensional space defined by embeddings representing the capabilities of the corresponding peer agent; evaluating, by the agent, the advertisements and determining a set of capabilities accessible through the agent, wherein the set of capabilities includes capabilities provided by the agent and at least one peer agent; and advertising, by the agent, the set of capabilities to peer agents to indicate the set of capabilities accessible through the agent.

In one example, the agent and the peer agents include artificial intelligence agents and the region for the corresponding peer agent is defined by a set of embeddings of intents and contexts for the corresponding peer agent, wherein the set of embeddings includes ranges for each dimension, and wherein the corresponding peer agent is identified to process a request based on dimensions of an embedding of the request being within the ranges of the set of embeddings for the region for the corresponding peer agent.

In one example, the network routing protocol includes a Border Gateway Protocol (BGP)-based protocol, and an advertisement includes a BGP update message modified to include the boundaries of the region for the corresponding peer agent.

In one example, the network routing protocol includes an Open Shortest Path First (OSPF)-based protocol, and an advertisement includes an OSPF packet modified to include the boundaries of the region for the corresponding peer agent.

In one example, the network routing protocol includes a first network routing protocol for routing requests between domains, and a second different network routing protocol for routing requests within a domain.

In one example, the advertisements are received from a plurality of peer agents that reside in a domain of the network, and the method further comprises aggregating, via the agent, the boundaries of regions in the advertisements to produce a summary of the capabilities for the plurality of peer agents, and advertising, via the agent, the summary of the capabilities to an external domain to hide identities of the plurality of peer agents.

In one example, a request is received from the external domain based on a region in the multidimensional space associated with the summary of the capabilities encompassing an embedding of the request.

In another form, an apparatus is provided. The apparatus comprises a network interface to enable communications in a network; a memory; and at least one processor of an agent configured to perform operations including: receiving advertisements from at least one peer agent via a network routing protocol, wherein an advertisement includes capabilities provided by a corresponding peer agent and indicated by boundaries of a region in a multidimensional space defined by embeddings representing the capabilities of the corresponding peer agent; evaluating the advertisements and determining a set of capabilities accessible through the agent, wherein the set of capabilities includes capabilities provided by the agent and at least one peer agent; and advertising the set of capabilities to peer agents to indicate the set of capabilities accessible through the agent.

In another form, one or more non-transitory computer readable storage media are provided. The one or more non-transitory computer readable storage media are encoded with processing instructions that, when executed by one or more processors of an agent of a network, cause the one or more processors to perform operations including: receiving advertisements from at least one peer agent via a network routing protocol, wherein an advertisement includes capabilities provided by a corresponding peer agent and indicated by boundaries of a region in a multidimensional space defined by embeddings representing the capabilities of the corresponding peer agent; evaluating the advertisements and determining a set of capabilities accessible through the agent, wherein the set of capabilities includes capabilities provided by the agent and at least one peer agent; and advertising the set of capabilities to peer agents to indicate the set of capabilities accessible through the agent.

The above description is intended by way of example only. Although the techniques are illustrated and described herein as embodied in one or more specific examples, it is nevertheless not intended to be limited to the details shown, since various modifications and structural changes may be made within the scope and range of equivalents of the claims.

What is claimed is:

1. A method comprising:
receiving, by an agent of a network, advertisements from at least one peer agent via a network routing protocol, wherein an advertisement includes capabilities provided by a corresponding peer agent and indicated by boundaries of a region in a multidimensional space defined by embeddings representing the capabilities of the corresponding peer agent;
evaluating, by the agent, the advertisements and determining a set of capabilities accessible through the agent, wherein the set of capabilities includes capabilities provided by the agent and at least one peer agent; and
advertising, by the agent, the set of capabilities to peer agents to indicate the set of capabilities accessible through the agent.

2. The method of claim 1, wherein the agent and the peer agents include artificial intelligence agents and the region for the corresponding peer agent is defined by a set of embeddings of intents and contexts for the corresponding peer agent, wherein the set of embeddings includes ranges for each dimension, and wherein the corresponding peer agent is identified to process a request based on dimensions of an embedding of the request being within the ranges of the set of embeddings for the region for the corresponding peer agent.

3. The method of claim 1, wherein the network routing protocol includes a Border Gateway Protocol (BGP)-based protocol, and an advertisement includes a BGP update message modified to include the boundaries of the region for the corresponding peer agent.

4. The method of claim 1, wherein the network routing protocol includes an Open Shortest Path First (OSPF)-based protocol, and an advertisement includes an OSPF packet modified to include the boundaries of the region for the corresponding peer agent.

5. The method of claim 1, wherein the network routing protocol includes a first network routing protocol for routing requests between domains, and a second different network routing protocol for routing requests within a domain.

6. The method of claim 1, wherein the advertisements are received from a plurality of peer agents that reside in a domain of the network, and the method further comprises:
aggregating, via the agent, the boundaries of regions in the advertisements to produce a summary of the capabilities for the plurality of peer agents; and
advertising, via the agent, the summary of the capabilities to an external domain to hide identities of the plurality of peer agents.

7. The method of claim 6, wherein a request is received from the external domain based on a region in the multidimensional space associated with the summary of the capabilities encompassing an embedding of the request.

8. An apparatus comprising:
a network interface to enable communications in a network;
a memory; and
at least one processor of an agent configured to perform operations including:
receiving advertisements from at least one peer agent via a network routing protocol, wherein an advertisement includes capabilities provided by a corresponding peer agent and indicated by boundaries of a region in a multidimensional space defined by embeddings representing the capabilities of the corresponding peer agent;
evaluating the advertisements and determining a set of capabilities accessible through the agent, wherein the set of capabilities includes capabilities provided by the agent and at least one peer agent; and
advertising the set of capabilities to peer agents to indicate the set of capabilities accessible through the agent.

9. The apparatus of claim 8, wherein the agent and the peer agents include artificial intelligence agents and the region for the corresponding peer agent is defined by a set of embeddings of intents and contexts for the corresponding peer agent, wherein the set of embeddings includes ranges for each dimension, and wherein the corresponding peer agent is identified to process a request based on dimensions of an embedding of the request being within the ranges of the set of embeddings for the region for the corresponding peer agent.

10. The apparatus of claim 8, wherein the network routing protocol includes a Border Gateway Protocol (BGP)-based protocol, and an advertisement includes a BGP update message modified to include the boundaries of the region for the corresponding peer agent.

11. The apparatus of claim 8, wherein the network routing protocol includes an Open Shortest Path First (OSPF)-based protocol, and an advertisement includes an OSPF packet modified to include the boundaries of the region for the corresponding peer agent.

12. The apparatus of claim 8, wherein the network routing protocol includes a first network routing protocol for routing requests between domains, and a second different network routing protocol for routing requests within a domain.

13. The apparatus of claim 8, wherein the advertisements are received from a plurality of peer agents that reside in a domain of the network, and the at least one processor is configured to perform further operations including:
aggregating the boundaries of regions in the advertisements to produce a summary of the capabilities for the plurality of peer agents; and
advertising the summary of the capabilities to an external domain to hide identities of the plurality of peer agents.

14. One or more non-transitory computer readable storage media encoded with processing instructions that, when executed by one or more processors of an agent of a network, cause the one or more processors to perform operations including:
receiving advertisements from at least one peer agent via a network routing protocol, wherein an advertisement includes capabilities provided by a corresponding peer agent and indicated by boundaries of a region in a multidimensional space defined by embeddings representing the capabilities of the corresponding peer agent;
evaluating the advertisements and determining a set of capabilities accessible through the agent, wherein the set of capabilities includes capabilities provided by the agent and at least one peer agent; and
advertising the set of capabilities to peer agents to indicate the set of capabilities accessible through the agent.

15. The one or more non-transitory computer readable storage media of claim 14, wherein the agent and the peer agents include artificial intelligence agents and the region for the corresponding peer agent is defined by a set of embeddings of intents and contexts for the corresponding peer agent, wherein the set of embeddings includes ranges for each dimension, and wherein the corresponding peer agent is identified to process a request based on dimensions of an embedding of the request being within the ranges of the set of embeddings for the region for the corresponding peer agent.

16. The one or more non-transitory computer readable storage media of claim 14, wherein the network routing protocol includes a Border Gateway Protocol (BGP)-based protocol, and an advertisement includes a BGP update message modified to include the boundaries of the region for the corresponding peer agent.

17. The one or more non-transitory computer readable storage media of claim 14, wherein the network routing protocol includes an Open Shortest Path First (OSPF)-based protocol, and an advertisement includes an OSPF packet modified to include the boundaries of the region for the corresponding peer agent.

18. The one or more non-transitory computer readable storage media of claim 14, wherein the network routing protocol includes a first network routing protocol for routing requests between domains, and a second different network routing protocol for routing requests within a domain.

19. The one or more non-transitory computer readable storage media of claim 14, wherein the advertisements are received from a plurality of peer agents that reside in a domain of the network, and the processing instructions further cause the one or more processors to perform operations including:
aggregating the boundaries of regions in the advertisements to produce a summary of the capabilities for the plurality of peer agents; and
advertising the summary of the capabilities to an external domain to hide identities of the plurality of peer agents.

20. The one or more non-transitory computer readable storage media of claim 19, wherein a request is received from the external domain based on a region in the multidimensional space associated with the summary of the capabilities encompassing an embedding of the request.
